(19) United States
(12) Patent Application Publication
(10) Pub. No.: US 2015/0063098 A1
(43) Pub. Date: Mar. 5, 2015

(54) REDUCING INTERFERENCE FROM LTE IN UNLICENSED BANDS

(71) Applicant: QUALCOMM Incorporated, San Diego, CA (US)

(72) Inventors: Mehmet YAVUZ, San Diego, CA (US); Ahmed Kamel SADEK, San Diego, CA (US)

(21) Appl. No.: 14/446,550

(22) Filed: Jul. 30, 2014

Related U.S. Application Data
(60) Provisional application No. 61/873,717, filed on Sep. 4, 2013.

(51) Int. Cl. H04W 24/02; H04W 52/24; H04W 28/02; H04L 5/14

(52) U.S. Cl. CPC H04W 24/02; H04L 5/14; H04W 52/243; H04W 28/0236
USPC 370/229; 370/254; 370/252

(57) ABSTRACT

The disclosure relates to reducing Wi-Fi interference from small cells that provide cellular coverage in unlicensed bands. In particular, in response to determining that a small cell is substantially unloaded (e.g., has traffic below a threshold), the small cell may be switched to a reduced interference configuration. For example, the small cell may be switched to a low downlink configuration to reduce interference in a time domain and/or a low bandwidth configuration to reduce interference in a frequency domain. Alternatively (or additionally), the small cell and/or any other small cells that have traffic below the threshold may switch to the same frequency and/or channel number to concentrate all possible interference on the same frequency and/or channel number. Further still, the configuration may be switched in a power domain, where a transmit power associated with the small cell may be adapted based on cellular measurements in combination with Wi-Fi measurements.

### CROSS-REFERENCE TO RELATED APPLICATIONS

The present Application for Patent claims the benefit of Provisional Patent Application No. 61/873,717 entitled “REDUCING INTERFERENCE FROM LTE IN UNLICENSED BANDS,” filed on Sep. 4, 2013, assigned to the assignee hereof and hereby expressly incorporated by reference herein in its entirety.

### BACKGROUND

Wireless communication systems are widely deployed to provide various types of communication content, such as voice, data, and so on. Typical wireless communication systems are multiple-access systems capable of supporting communication with multiple users by sharing available system resources (e.g., bandwidth, transmit power, etc.). Examples of such multiple-access systems include code division multiple access (CDMA) systems, time division multiple access (TDMA) systems, frequency division multiple access (FDMA) systems, orthogonal frequency division multiple access (OFDMA) systems, and others. These systems are often deployed in conformity with specifications such as third generation partnership project (3GPP), 3GPP long term evolution (LTE), ultra mobile broadband (UMB), evolution data optimized (EV-DO), etc.

In cellular networks, macro scale base stations (or macro NodeBs (MNBs)) provide connectivity and coverage to a large number of users over a certain geographical area. A macro network deployment is carefully planned, designed, and implemented to offer good coverage over the geographical region. Even such careful planning, however, cannot fully accommodate channel characteristics such as fading, multipath, shadowing, etc., especially in indoor environments. Indoor users therefore often face coverage issues (e.g., call outages and quality degradation) resulting in poor user experience.

To extend cellular coverage indoors, such as for residential homes and office buildings, additional small coverage, typically low power base stations have recently begun to be deployed to supplement conventional macro networks, providing more robust wireless coverage for mobile devices. These small coverage base stations are commonly referred to as Home NodeBs or Home eNBs (collectively, H(e)NBs), femto nodes, femtocells, femtocell base stations, pico nodes, micro nodes, etc., which may be deployed for incremental capacity growth, richer user experience, in-building or other specific geographic coverage, and so on. Such small coverage base stations may be connected to the Internet and the mobile operator's network via a digital subscriber line (DSL) router or a cable modem, for example. However, an unplanned deployment of large numbers of small coverage base stations (or simply “small cells”) can be challenging in several respects.

### SUMMARY

The disclosure generally relates to reducing pilot pollution and/or mitigating potential Wi-Fi interference from a small cell that provides cellular (e.g., LTE) coverage in unlicensed bands. In particular, in response to determining that a small cell has no traffic or traffic below a threshold, the small cell may be considered substantially unloaded and therefore switch to a configuration that may reduce pilot pollution and/or mitigate potential Wi-Fi interference. For example, switching the configuration associated with the small cell may comprise switching the small cell to a low downlink configuration, switching the small cell to a low bandwidth configuration, moving the small cell and one or more additional small cells that have no traffic or traffic below the threshold to the same frequency and/or channel number, managing a transmit power associated with the small cell in a manner that may balance tradeoffs between network coverage, capacity, and interference impact based on cellular measurements in combination with Wi-Fi measurements, or any suitable combination thereof

According to one aspect of the disclosure, a method for reducing interference from a small cell that provides cellular coverage in unlicensed bands may comprise, among other things, determining a load associated with the small cell and switching the small cell to a reduced interference configuration in response to the determined load indicating that traffic associated with the small cell is below a threshold, wherein the small cell may switch to the reduced interference configuration in at least one of a time domain, a frequency domain, or a power domain. For example, switching the small cell to the reduced interference configuration in the time domain may comprise switching the small cell to a low downlink configuration (e.g., time division duplexing (TDD) Config0 and special subframe (SSF) Config5). In another example, switching the small cell to the reduced interference configuration in the frequency domain may comprise switching the unloaded small cell to a low bandwidth configuration (e.g., a 1.25 MHz bandwidth configuration, whereas the small cell may normally operate according to a 20 MHz bandwidth configuration or another suitable high bandwidth configuration). Alternatively (or additionally), where the small cell comprises one of multiple unloaded small cells (e.g., multiple small cells that have no traffic or traffic below the threshold), switching the small cell to the reduced interference configuration in the frequency domain may comprise moving each unloaded small cell to the same frequency and/or channel number such that all possible interference from the unloaded small cells may be aggregated on the same frequency and/or channel number and all other frequencies and/or channel numbers may be free from interference. According to another aspect, switching the small cell to the reduced interference configuration in the power domain may comprise adapting a transmit power associated with the small cell to balance tradeoffs between coverage, capacity, and interference impact based on one or more cellular measurements in combination with one or more Wi-Fi measurements. For example, a received signal code power (RSCP) threshold may be determined based on one or more measured Wi-Fi signals and the transmit power associated with the small cell may be reduced in response to the measured Wi-Fi signals exceeding a first threshold and the measured cellular signals exceeding the RSCP threshold. Furthermore, the RSCP threshold may be reduced if the measured Wi-Fi signals exceed a second threshold such that the transmit power may be reduced more aggressively when stronger Wi-Fi signals are measured.

According to another aspect of the disclosure, a small cell may comprise, among other things, an air interface configured to provide cellular coverage in unlicensed bands and a host comprising at least one processor configured to determine a load associated with the small cell and switch a configuration associated with the small cell in at least one of a time domain, a frequency domain, or a power domain in response to the determined load indicating that the small cell has traffic below a threshold. For example, in one implementation, the at least one processor may be configured to switch the configuration associated with the small cell to a low downlink configuration to reduce interference in the time domain. In other examples, the at least one processor may be configured to switch the configuration associated with the small cell to a low bandwidth configuration and/or switch the small cell to one or more of the same frequency or the same channel number as one or more additional small cells that have traffic below the threshold to reduce interference in the frequency domain. In still another example, the at least one processor may be configured to adapt a transmit power associated with the small based on cellular measurements in combination with Wi-Fi measurements to reduce interference in the power domain.

According to another aspect of the disclosure, an apparatus may comprise means for determining a load associated with a small cell that provides cellular coverage in unlicensed bands and means for switching a configuration associated with the small cell to reduce interference in at least one of a time domain, a frequency domain, or a power domain in response to the small cell having traffic below a threshold. For example, in one implementation, the means for switching may be configured to switch the configuration associated with the small cell to a low downlink configuration to reduce interference in the time domain, to switch the configuration associated with the small cell to one or more of a low bandwidth configuration, the same frequency as one or more additional small cells that have traffic below the threshold, or the same channel number as the one or more additional small cells that have traffic below the threshold to reduce interference in the frequency domain, and/or to adapt a transmit power associated with the small based on cellular measurements in combination with Wi-Fi measurements to reduce interference in the power domain.

According to another aspect of the disclosure, a computer-readable storage medium may have computer-executable instructions recorded thereon, wherein executing the computer-executable instructions on at least one processor may cause the at least one processor to determine a load associated with a small cell that provides cellular coverage in unlicensed bands and switch a configuration associated with the small cell to reduce interference in at least one of a time domain, a frequency domain, or a power domain in response to load indicating that the small cell has traffic below a threshold. For example, in various implementations, the configuration associated with the small cell may be switched to a low downlink configuration to reduce interference in the time domain, the configuration associated with the small cell may be switched to one or more of a low bandwidth configuration, the same frequency as one or more additional small cells that have traffic below the threshold, or the same channel number as the one or more additional small cells that have traffic below the threshold to reduce interference in the frequency domain, and/or a transmit power associated with the small may be adapted based on cellular measurements in combination with Wi-Fi measurements to reduce interference in the power domain.

Other objects and advantages associated with the aspects disclosed herein will be apparent to those skilled in the art based on the accompanying drawings and the following detailed description.

### BRIEF DESCRIPTION OF THE DRAWINGS

The accompanying drawings are presented to aid in describing various aspects of the disclosure and are provided solely for illustration and not limitation thereof

FIG. 1 illustrates an exemplary Evolved Packet System (EPS) or Long Term Evolution (LTE) network architecture, according to one aspect of the disclosure

FIG. 2 illustrates an exemplary wireless communication network demonstrating principles of multiple access communication, according to one aspect of the disclosure.

FIG. 3 illustrates an exemplary environment having two or more systems that share a particular spectrum, according to one aspect of the disclosure.

FIG. 4 illustrates an exemplary wireless communication system operable in a shared spectrum environment such as the exemplary environment illustrated in FIG. 3, according to one aspect of the disclosure.

FIG. 5A illustrates an exemplary mixed communication network environment in which small cells are deployed in conjunction with macro cells and FIG. 5B illustrates an exemplary small cell that may be used in the mixed communication network environment shown in FIG. 5A, according to various aspects of the disclosure.

FIG. 6 illustrates an exemplary small cell apparatus that may correspond to the small cells shown in FIGS. 5A-5B and/or be used in the mixed communication network environment shown in FIG. 5A, according to one aspect of the disclosure.

FIG. 7A illustrates an exemplary transmission structure that may be used on a downlink in a shared spectrum and/or mixed communication network environment, according to one aspect of the disclosure.

FIG. 7B illustrate exemplary coexistence signaling messages that may be broadcasted in a shared or unlicensed spectrum environment to enable inter-operator coexistence, according to one aspect of the disclosure.

FIG. 8 illustrates an exemplary method to reduce interference from an unloaded small cell that provides cellular coverage in unlicensed bands, according to one aspect of the disclosure.

FIG. 9 illustrates another exemplary method to reduce interference from an unloaded small cell that provides cellular coverage in unlicensed bands, according to one aspect of the disclosure.

FIG. 10 illustrates an exemplary modular architecture that may be used to reduce interference from an unloaded small cell that provides cellular coverage in unlicensed bands, according to one aspect of the disclosure.

FIG. 11 illustrates an exemplary system that may facilitate reducing interference from a small cell that provides cellular coverage in unlicensed bands, according to one aspect of the disclosure.

FIG. 12 illustrates a communication device that includes logic configured to perform functionality, according to one aspect of the disclosure.

FIG. 13 illustrates an exemplary server that may be used in connection with any implementation and/or aspect described herein.

### DETAILED DESCRIPTION

Various aspects are disclosed in the following description and related drawings. Alternate aspects may be devised without departing from the scope of the disclosure. Additionally, well-known elements of the disclosure will not be described in detail or will be omitted so as not to obscure the relevant details of the disclosure.

The word “exemplary” is used herein to mean “serving as an example, instance, or illustration.” Any aspect described herein as “exemplary” is not necessarily to be construed as preferred or advantageous over other aspects. Likewise, the term “aspects of the disclosure” does not require that all aspects of the disclosure include the discussed feature, advantage or mode of operation.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof

Further, various aspects are described in terms of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

According to various aspects of the disclosure, various mechanisms described herein may generally relate to techniques that may be used to reduce Wi-Fi interference from an unloaded small cell that provides cellular (e.g., LTE) coverage in unlicensed bands. For example, in response to determining that the unloaded small cell may cause interference with one or more Wi-Fi signals, the unloaded small cell may switch to a low downlink configuration (e.g., a configuration that has relatively few downlink subframes and more uplink subframes such that there may be less downlink activity that may interfere with Wi-Fi signals transmitted within or near to a coverage area associated with the small cell). In another example, the unloaded small cell may switch to a low bandwidth configuration, which may reduce the interference with any Wi-Fi signals in or near to the coverage area associated with the small cell according to a factor based on the difference between the original bandwidth configuration and the low bandwidth configuration. Furthermore, in the event that there may be multiple unloaded small cells, each unloaded small cell may switch to the same frequency and/or channel number such that all possible interference from the unloaded small cells may be aggregated on the same frequency and/or channel number and all other frequencies and/or channel numbers may be free from interference. In still another example, the unloaded small cell may use cellular measurements in combination with Wi-Fi measurements to manage a transmit power associated therewith in a manner that may balance tradeoffs between network coverage, capacity, and interference impact. Furthermore, in certain use cases, the small cell may use any one of the above-mentioned interference reduction techniques in a standalone manner or more than one of the above-mentioned interference reduction techniques in combination (e.g., according to a hierarchy that defines a sequence to apply the different interference reduction techniques) and/or exit the reduced interference mode in the event that the small cell subsequently experiences an increased load and therefore is no longer substantially unloaded.

The techniques described herein may be employed in networks that include macro scale coverage (e.g., a large area cellular network such as 3G or 4G networks, typically referred to as a macro cell network) and smaller scale coverage (e.g., a residence-based or building-based network environment). As a user device moves through such networks, the user device may be served in certain locations by base stations that provide macro coverage and at other locations by base stations that provide smaller scale coverage. As discussed briefly in the background above, the smaller coverage base stations may be used to provide significant capacity growth, in-building coverage, and in some cases different services for a more robust user experience. In the discussion herein, a base station that provides coverage over a relatively large area is usually referred to as a macro base station, while a base station that provides coverage over a relatively small area (e.g., a residence) is usually referred to as a femto base station or more generally a “small cell.” Intermediate base stations that provide coverage over an area that is smaller than a macro area but larger than a femto area are usually referred to as pico base stations (e.g., providing coverage within a commercial building). For convenience, however, the disclosure herein may describe various functionalities in contexts that relate to small cells or other suitable small coverage base stations, with the understanding that a pico base station may provide the same or similar functionality for a larger coverage area. A cell associated with a macro base station, a small cell, or a pico base station may be referred to as a macrocell, a femtocell, or a picocell, respectively. In some system implementations, each cell may be further associated with (e.g., divided into) one or more sectors.

In various applications, it will be appreciated that other terminology may be used to reference a macro base station, a small cell (or femto base station), a pico base station, a user device, and/or other devices. However, those skilled in the art will further appreciate that the use of such terms is generally not intended to invoke or exclude a particular technology in relation to the aspects described or otherwise facilitated by the description herein. For example, a macro base station may be configured or alternatively referred to as a macro node, NodeB, evolved NodeB (eNodeB), macrocell, and so on. A small cell may be configured or alternatively referred to as a femto base station, a femto node, a Home NodeB, a Home eNodeB, a femtocell, a small coverage base station, and so on. A user device may be configured or alternatively referred to as a device, user equipment (UE), subscriber unit, subscriber station, mobile station, mobile device, access terminal, and so on. For convenience, the disclosure herein will tend to describe various functionalities in the context of generic “base stations” and “user devices,” which, unless otherwise indicated by the particular context of the description, are intended to cover the corresponding technology and terminology in all wireless systems.

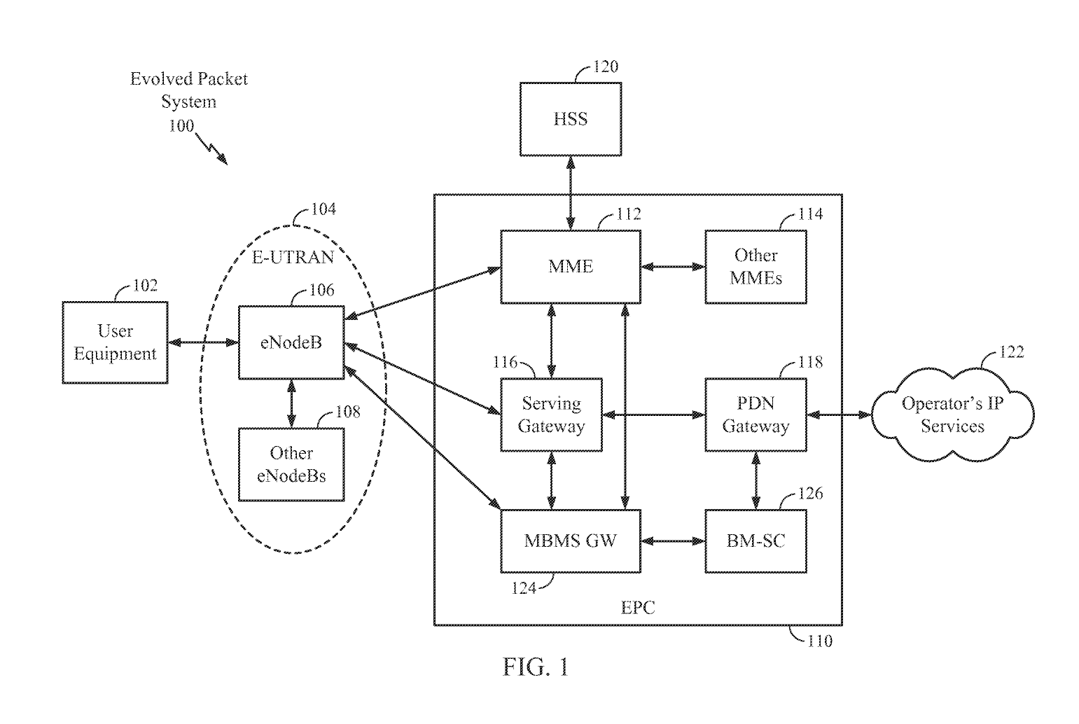

According to one aspect of the disclosure, FIG. 1 illustrates an exemplary Long Term Evolution (LTE) network architecture 100, which may also be referred to as an Evolved Packet System (EPS). In one implementation, the EPS 100 may include at least one user equipment (UE) 102, an Evolved UMTS Terrestrial Radio Access Network (E-UTRAN) 104, an Evolved Packet Core (EPC) 110, a Home Subscriber Server (HSS) 120, and an Operator's Internet Protocol (IP) Services 122. The EPS 100 can interconnect with other access networks, but for simplicity those entities/interfaces are not shown. As shown, the EPS 100 provides packet-switched services, however, as those skilled in the art will readily appreciate, the various concepts presented throughout this disclosure may be extended to networks providing circuit-switched services.

In one implementation, the E-UTRAN 104 may include the evolved Node B (eNB) 106 and other eNBs 108. The eNB 106 may provide user and control plane protocol terminations toward the UE 102 and may be connected to other eNBs 108 via a backhaul (e.g., an X2 interface). The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is may be connected to the EPC 110, which includes a Mobility Management Entity (MME) 112, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, an intranet, an IP Multimedia Subsystem (IMS), and a PS Streaming Service (PSS). The BM-SC 126 may provide functions for MBMS user service provisioning and delivery. The BM-SC 126 may serve as an entry point for content provider MBMS transmission, may be used to authorize and initiate MBMS Bearer Services within a PLMN, and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information.

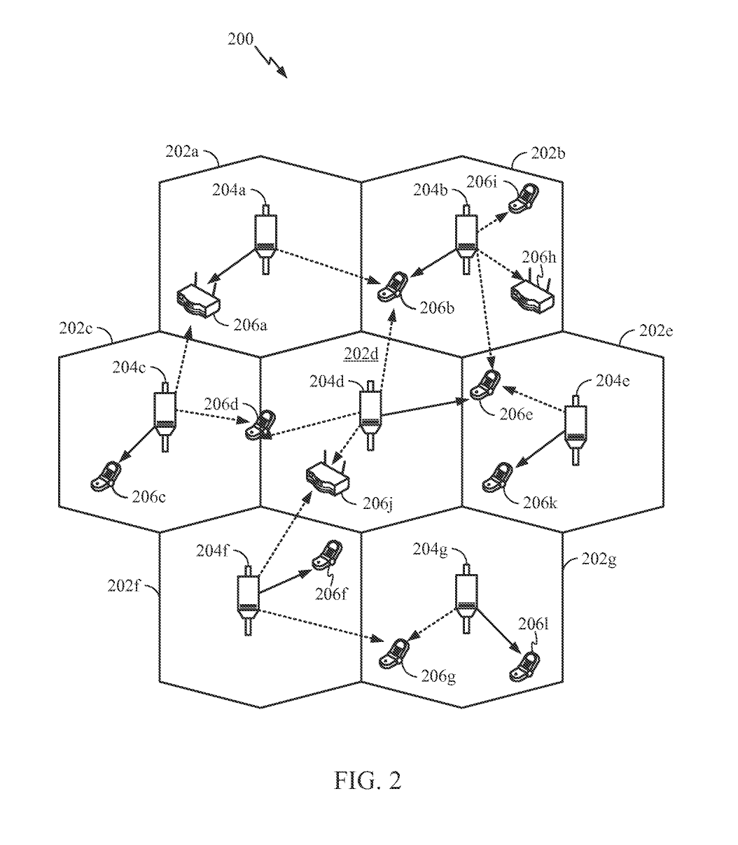

FIG. 2 illustrates an example wireless communication network demonstrating the principles of multiple access communication. The illustrated wireless communication network 200 is configured to support communication between a number of users. As shown, the wireless communication network 200 may be divided into one or more cells 202, such as the illustrated cells 202A-202G. Communication coverage in cells 202A-202G may be provided by one or more base stations 204, such as the illustrated base stations 204A-204G. In this way, each base station 204 may provide communication coverage to a corresponding cell 202. The base station 204 may interact with a plurality of user devices 206, such as the illustrated user devices 206A-206L.

Each user device 206 may communicate with one or more of the base stations 204 on a downlink (DL) and/or an uplink (UL). In general, a DL is a communication link from a base station to a user device, while an UL is a communication link from a user device to a base station. The base stations 204 may be interconnected by appropriate wired or wireless interfaces allowing them to communicate with each other and/or other network equipment. Accordingly, each user device 206 may also communicate with another user device 206 through one or more of the base stations 204. For example, the user device 206J may communicate with the user device 206H in the following manner: the user device 206J may communicate with the base station 204D, the base station 204D may then communicate with the base station 204B, and the base station 204B may then communicate with the user device 206H, allowing communication to be established between the user device 206J and the user device 206H.

The wireless communication network 200 may provide service over a large geographic region. For example, the cells 202A-202G may cover a few blocks within a neighborhood or several square miles in a rural environment. As noted above, in some systems, each cell may be further divided into one or more sectors (not shown). In addition, the base stations 204 may provide the user devices 206 access within their respective coverage areas to other communication networks, such as the Internet or another cellular network. As further mentioned above, each user device 206 may be a wireless communication device (e.g., a mobile phone, router, personal computer, server, etc.) used by a user to send and receive voice or data over a communications network, and may be alternatively referred to as an access terminal (AT), a mobile station (MS), a user equipment (UE), etc. In the example shown in FIG. 2, the user devices 206A, 206H, and 206J comprise routers, while the user devices 206B-206G, 206I, 206K, and 206L comprise mobile phones. Again, however, each of the user devices 206A-206L may comprise any suitable communication device.

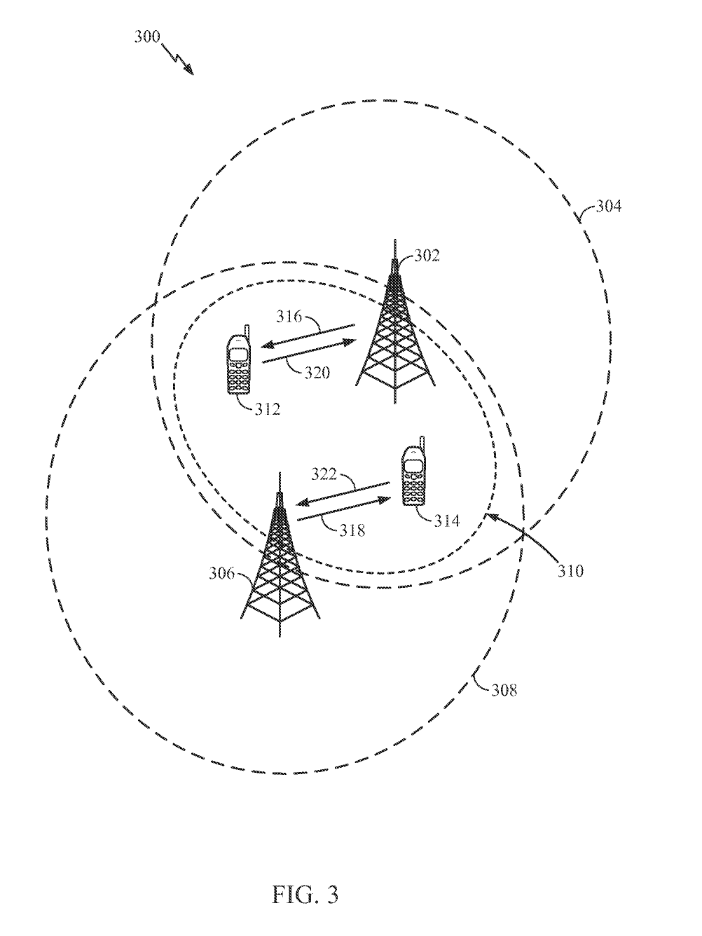

According to one aspect of the disclosure, FIG. 3 illustrates an exemplary environment 300 having two or more systems sharing a particular spectrum (e.g., an unlicensed cellular band). A base station (BS) 302 effects coverage 304 for a first system or network, such as a packet based system, although not limited to such. Similarly, a second system (e.g., another packet base system) is effected with base station (BS) 306 having a coverage area 308. For purposes of illustration, FIG. 3 shows a common environment 310 where spectrum is shared among at least the two systems implemented by BS 302 and BS 306. It is noted that the geometries and areas illustrated are merely exemplary and environment 310 connotes any environment where spectrum is capable of being shared among at least a primary system and at one secondary system. Furthermore, FIG. 3 is illustrative of the case of heterogeneous networks with BS 302 effecting a first network differing from system parameters of the second network effected by BS 306. Additionally, the illustrated first and second networks may be either a primary and secondary network, respectively, or both secondary networks. Each system is operable for communication to one or more subscriber stations (SS) illustrated by a first SS 312 in communication with BS 302 and a second SS314 in communication with BS 306. Each SS 312, 314 is respectively capable of communication with BS 302, 306 in both a downlink (DL) channel(s) 316 and 318 and uplink (UL) 320 and 322.

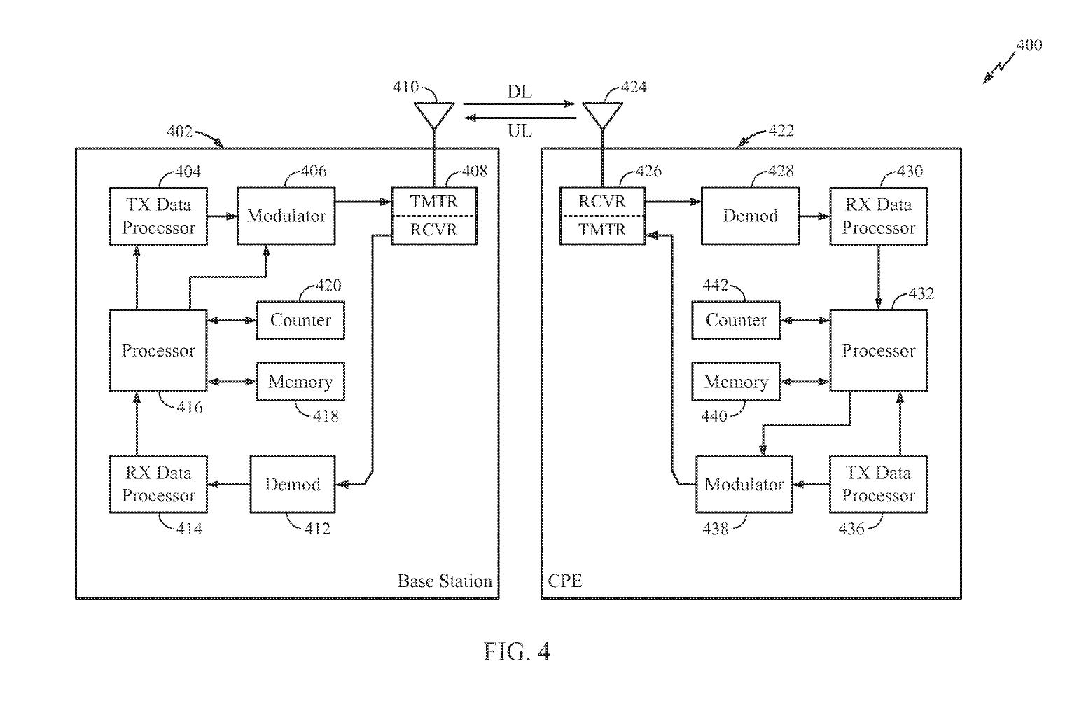

According to one aspect of the disclosure, FIG. 4 illustrates an exemplary wireless communication system 400 operable in a shared spectrum environment such as the environment illustrated in FIG. 3 and described above. In one implementation, system 400 includes a base station or access point 402 having a transmit (TX) data processor 404, which may receive data to be transmitted from a data source (not shown). In an example, TX data processor 404 formats, codes, and interleaves the traffic data for each data stream based on a particular coding scheme selected for that data stream to provide coded data, wherein the coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) in a modulator 406 based on a particular modulation scheme (e.g., BPSK, QSPK, M-PSK, or M-QAM) selected for that data stream to provide modulation symbols. For example, the data rate, coding, and modulation for each data stream may be determined by instructions performed by a processor 416 or similar device (e.g., a digital signal processor or a general processor).

The modulation symbols for all data streams are then provided to a transmitter/receiver 408, which may further process the modulation symbols (e.g., for OFDM). Transmitter/receiver 408 then provides modulation symbol streams wirelessly via antenna 410 to one or more CPEs or access terminals 422 via antennas 410 and 424. Additionally, the transmitter/receiver 408 receives and processes signals received via antenna 410 from the various CPEs (e.g., 422). Transmitter/receiver 408 received signals on the UL from the various CPEs, processing the received symbol stream to provide one or more analog signals (e.g., filters, amplifies, and downconverts) a respective received signal, digitizes the conditioned signal to provide samples, and further processes (e.g., channel estimation, demodulation, deinterleaving, etc.) and decodes the samples to provide a corresponding “received” symbol stream, such as through demodulator 412. An RX data processor 414 then receives and processes the received symbol streams based on a particular receiver processing technique to recover the traffic data for the data stream.

Processor 416 may also be communicatively coupled to a memory 418, similar medium configured to store computer-readable, or processor instructions. Furthermore, the base station may include a counter 420 or any similar device known in the art for incrementing and storing one or more count values. This count may be used, among other things, to keep a cumulative count of the time of transmission of terminals, whether DL transmission from the base station 402 or UL transmissions from CPEs in a particular system in which the terminals operate. Although shown as a separate unit 420, it is contemplated that the count functions effected thereby may be implemented by memory 418, processor 416, or any other suitable devices.

A transmitter/receiver 426 of the CPE 422 receives DL transmission signals on from a base station (e.g., 402) and processes received symbol streams or frames to provide one or more analog signals, and further conditions (e.g., amplifies, filters, upconverts, etc.) analog signals to provide a modulated signal suitable for transmission on the UL to the base station 402. Each CPE receiver 426 conditions (e.g., filters, amplifies, and downconverts) a respective received signal, digitizes the conditioned signal to provide samples, and further processes (e.g., channel estimation, demodulation, deinterleaving, etc.) and decodes the samples to provide a corresponding “received” symbol stream, such as through demodulator 428. An RX data processor 430 then receives and processes the received symbol streams based on a particular receiver processing technique to recover the traffic data for the data stream. The decoded data for each data stream may be then utilized by a processor 432, or similar device (e.g., a Digital Signal Processor (DSP)) or a general processor.

Processor 432 may also be communicatively coupled to a memory 440 or similar medium configured to store computer-readable or processor instructions. Furthermore, the base station may include a counter 442 or any similar device known in the art for incrementing and storing one or more count values. This count is the same as the count of counter 420 in a base station (e.g., 402) and may be used to keep a cumulative count of the time of transmission of terminals, whether DL transmission from the base station 402 or UL transmissions from CPEs in a particular system in which the terminals operate. Although shown as a separate unit 442, it is contemplated that the count functions effected thereby may be implemented by memory 418, processor 416, or any other suitable devices.

CPE 422 also includes a TX Data Processor 436 and Modulator 438 for preparing encoded and modulated symbols or frames to be transmitted over the UL. The encoded and modulated symbols are input to the transmitter/receiver 426 for transmission via antenna 424 to a base station, such as base station 402. At base station 402, the modulated signals from transmitter/receiver system 426 are received by antenna 410, conditioned by transmitter/receivers 408, demodulated by a demodulator 412, and processed by a RX data processor 414 to extract the DL message transmitted by the CPE 422. Processor 416 may then process the extracted message for further use in the base station.

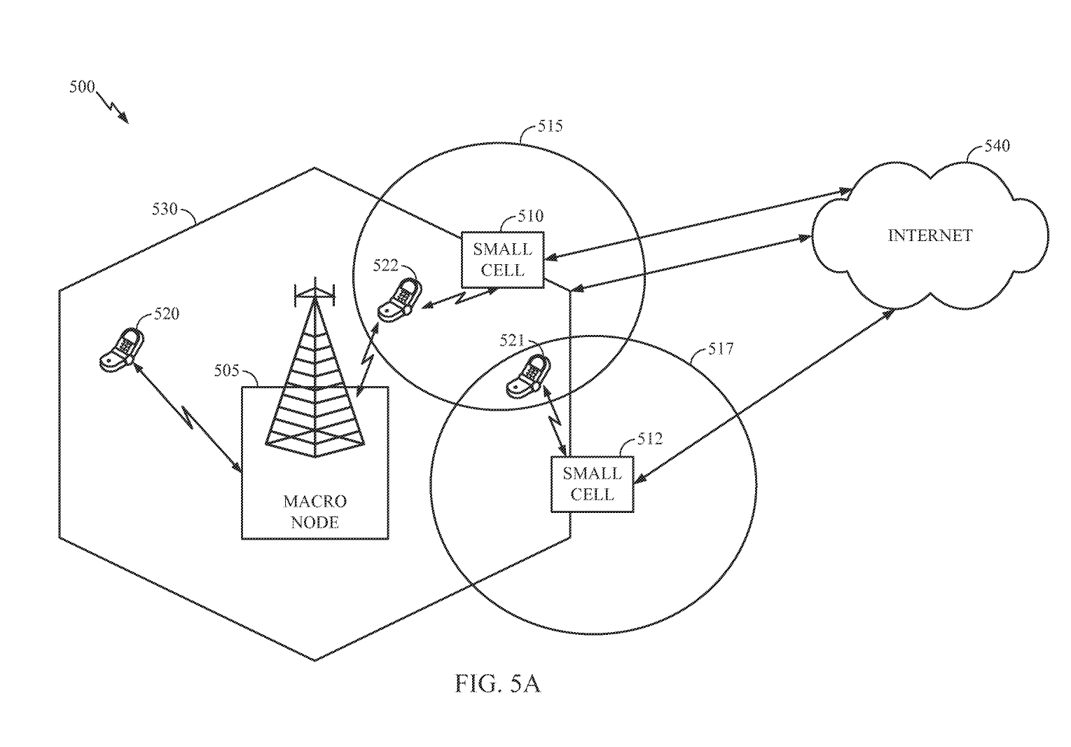

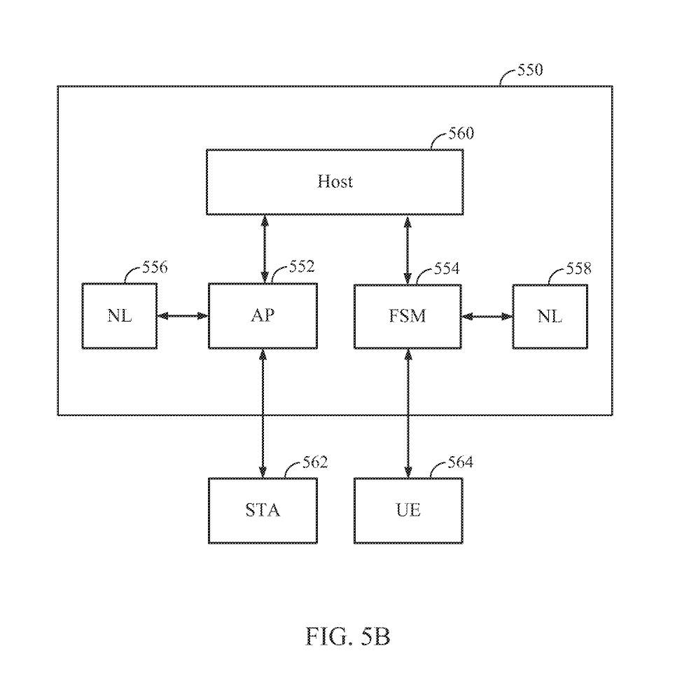

FIG. 5A illustrates an example mixed communication network environment 500 in which small cells 510 and 512 are deployed in conjunction with macro cells. Here, a macro base station 505 may provide communication coverage to one or more user devices, such as the illustrated user devices 520, 521, and 522, within a macro area 530, while small cells 510 and 512 may provide their own communication coverage within respective areas 515 and 517, with varying degrees of overlap among the different coverage areas. In this example, at least some user devices, such as the illustrated user device 522, may be capable of operating both in macro environments (e.g., macro areas) and in smaller scale network environments (e.g., residential areas, femto areas, pico areas, etc.).

In the connections shown, the user device 520 may generate and transmit a message via a wireless link to the macro base station 505, the message including information related to various types of communication (e.g., voice, data, multimedia services, etc.). The user device 522 may similarly communicate with the small cell 510 via a wireless link, and the user device 521 may similarly communicate with the small cells 512 via a wireless link. The macro base station 505 may also communicate with a corresponding wide area or external network 540 (e.g., the Internet), via a wired link or via a wireless link, while the small cells 510 and 512 may also similarly communicate with the network 540, via their own wired or wireless links. For example, the small cells 510 and 512 may communicate with the network 540 by way of an Internet Protocol (IP) connection, such as via a digital subscriber line (DSL, e.g., including asymmetric DSL (ADSL), high data rate DSL (HDSL), very high speed DSL (VDSL), etc.), a TV cable carrying IP traffic, a broadband over power line (BPL) connection, an optical fiber (OF) link, or some other link.

The network 540 may comprise any type of electronically connected group of computers and/or devices, including, for example, the following networks: Internet, Intranet, Local Area Networks (LANs), or Wide Area Networks (WANs). In addition, the connectivity to the network may be, for example, by remote modem, Ethernet (IEEE 802.3), Token Ring (IEEE 802.5), Fiber Distributed Datalink Interface (FDDI) Asynchronous Transfer Mode (ATM), Wireless Ethernet (IEEE 802.11), Bluetooth (IEEE 802.15.1), or some other connection. As used herein, the network 540 includes network variations such as the public Internet, a private network within the Internet, a secure network within the Internet, a private network, a public network, a value-added network, an intranet, and the like. In certain systems, the network 540 may also comprise a virtual private network (VPN).

Accordingly, it will be appreciated that the macro base station 505 and/or either or both of the small cells 510 and 512 may be connected to the network 540 using any of a multitude of devices or methods. These connections may be referred to as the “backbone” or the “backhaul” of the network. Devices such as a radio network controller (RNC), base station controller (BSC), or another device or system (not shown) may be used to manage communications between two or more macro base stations, pico base stations, and/or small cells. In this way, depending on the current location of the user device 522, for example, the user device 522 may access the communication network 540 by the macro base station 505 or by the small cell 510.

FIG. 5B illustrates an exemplary small cell 550 according to one or more aspects of the disclosure. The small cell 550 may correspond to the small cell 510 and/or the small cell 512 illustrated in FIG. 5A. The small cell 550 may be able to provide a wireless local area network (WLAN) air interface (e.g., in accordance with an IEEE 802.11x protocol) as well as a cellular air interface (e.g., in accordance with an LTE protocol). As shown, in this regard the small cell 550 can include an 802.11x Access Point (AP) 552 co-located with a Femtocell Site Modem (FSM) 554. The AP 552 and FSM 554 may perform monitoring of one or more channels (e.g., on a corresponding carrier frequency) to determine a corresponding channel quality (e.g., received signal strength) using corresponding network listen (NL) modules 556 and 558, respectively, or other suitable component(s). Although illustrated as separate modules, the NL modules 556 and 558 may reside on a single NL module.

The small cell 550 may also include a host 560, which may include one or more general purpose controllers or processors and memory configured to store related data or instructions. The host 560 may perform processing in accordance with the appropriate radio technology or technologies used for communication, as well as other functions for the small cell 550.

The small cell 550 may communicate with one or more wireless devices via the AP 552 and the FSM 554, illustrated as a station (STA) 562 and a UE 564, respectively. While FIG. 5B illustrates a single STA 562 and a single UE 564, it will be appreciated that the small cell 550 can communicate with multiple STAs and/or UEs. Additionally, while FIG. 5B illustrates one type of wireless device communicating with the small cell 550 via the AP 552 (i.e., the STA 562) and another type of wireless device communicating with the small cell 550 via the FSM 554 (i.e., the STA 564), it will be appreciated that a single wireless device may be capable of communicating with the small cell 550 via both of the AP 552 and the FSM 554, either simultaneously or at different times.

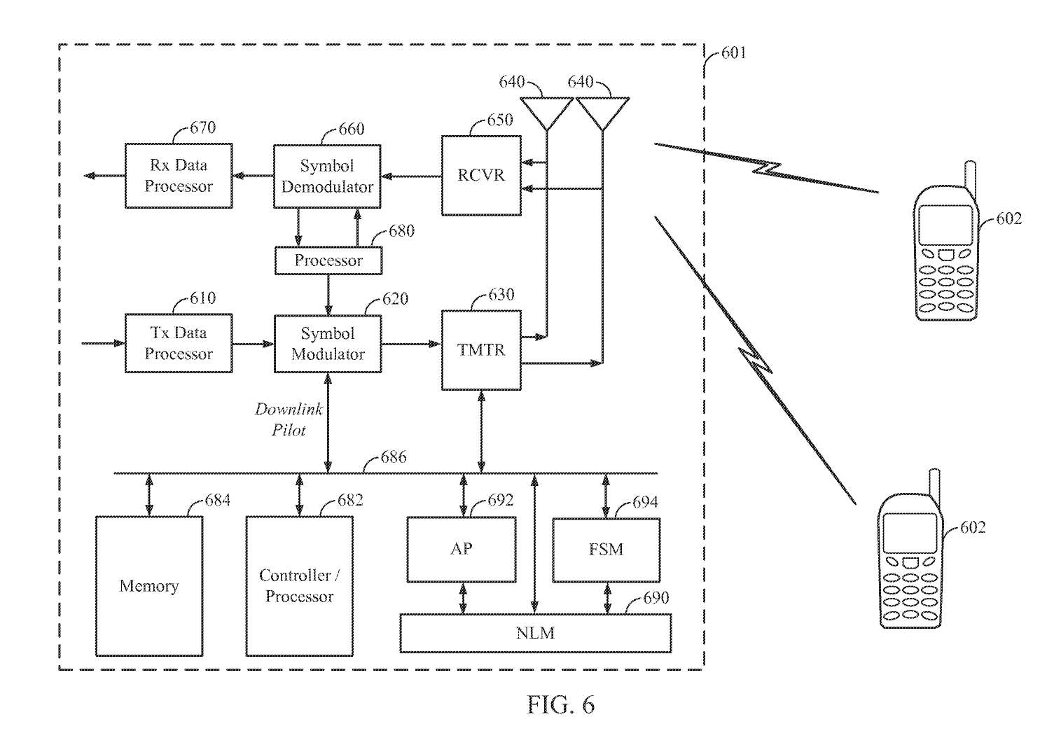

FIG. 6 illustrates an exemplary small cell 601 according to one or more aspects of the disclosure. The small cell 601 may correspond to any of small cells 510, 512, and/or 550. As shown, the small cell 601 includes a corresponding TX data processor 610, symbol modulator 620, transmitter unit (TMTR) 630, antenna(s) 640, receiver unit (RCVR) 650, symbol demodulator 660, RX data processor 670, and configuration information processor 680, performing various operations for communicating with one or more user devices 602. The small cell 601 may also include one or more general purpose controllers or processors (illustrated in the singular as the controller/processor 682) and memory 684 configured to store related data or instructions. Together, via a bus 686, these units may perform processing in accordance with the appropriate radio technology or technologies used for communication, as well as other functions for the small cell 601.

The small cell 601 may be able to provide a wireless local area network air interface (e.g., in accordance with an IEEE 802.11x protocol) as well as a cellular air interface (e.g., in accordance with an LTE protocol). As shown, in this regard the small cell 601 includes an 802.11x AP 692 co-located with an FSM 694. The AP 692 and the FSM 694 may correspond to the AP 552 and the FSM 554, respectively, illustrated in FIG. 5B. The AP 692 and the FSM 694 may perform monitoring of one or more channels (e.g., on a corresponding carrier frequency) to determine a corresponding channel quality (e.g., received signal strength) using a network listen module (NLM) or other suitable component (illustrated in the singular as the NLM 690). It will be appreciated that, in some designs, the functionality of one or more of these components may be integrated directly into, or otherwise performed by, the general purpose controller/processor 682 of the small cell 601, sometimes in conjunction with the memory 684.

The small cell 601 may communicate with the user devices 602 via the AP 692 and/or the FSM 694. It will be appreciated that a single user device 602 may be capable of communicating with the small cell 601 via both the AP 692 and the FSM 694, either simultaneously or at different times. In this disclosure, where a user device 602 is referred to as making and/or providing WLAN-specific measurements or performing WLAN-specific functionality, that user device 602 is understood to be connected to the AP 692. Likewise, where a user device 602 is referred to as making and/or providing cellular network-specific measurements or performing cellular network-specific functionality, that user device 602 is understood to be connected to the FSM 694.

In general, the AP 692 may provide its air interface (e.g., in accordance with an IEEE 802.11x protocol) over an unlicensed portion of the wireless spectrum such as an industrial, scientific, and medical (ISM) radio band, whereas the FSM 694 may provide its air interface (e.g., in accordance with an LTE protocol) over a licensed portion of the wireless band reserved for cellular communications. However, the FSM 694 may also be configured to provide cellular (e.g., LTE) coverage over an unlicensed portion of the wireless spectrum. This type of unlicensed cellular operation may include the use of an anchor licensed carrier operating in a licensed portion of the wireless spectrum (e.g., LTE Supplemental DownLink (SDL)) and an unlicensed portion of the wireless spectrum (e.g., LTE over unlicensed spectrum), or may be a standalone configuration operating without the use of an anchor licensed carrier (e.g., LTE Standalone).

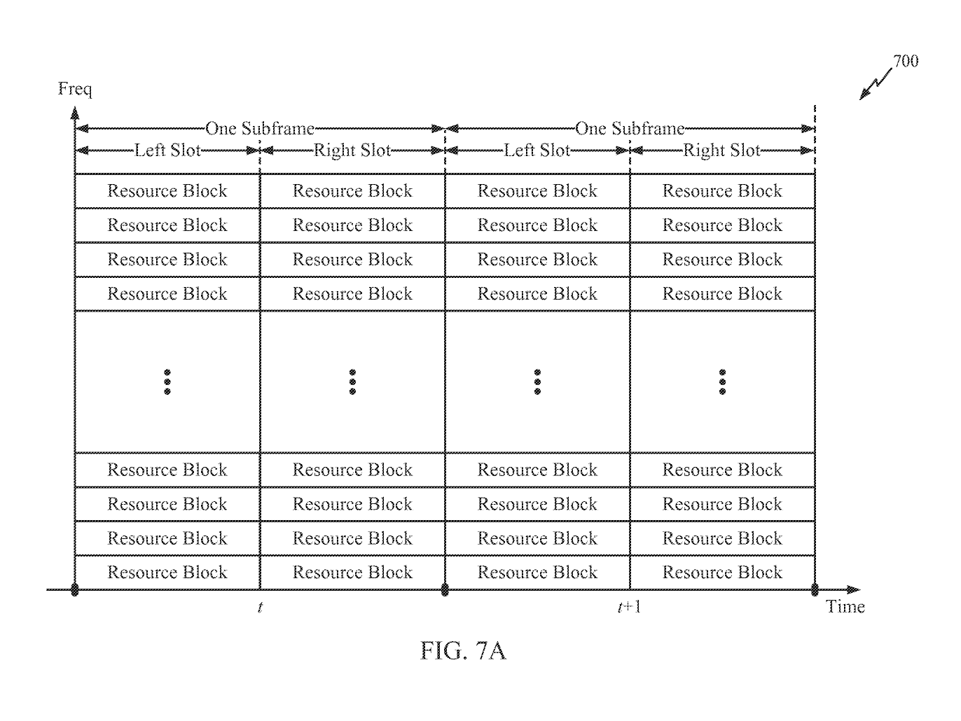

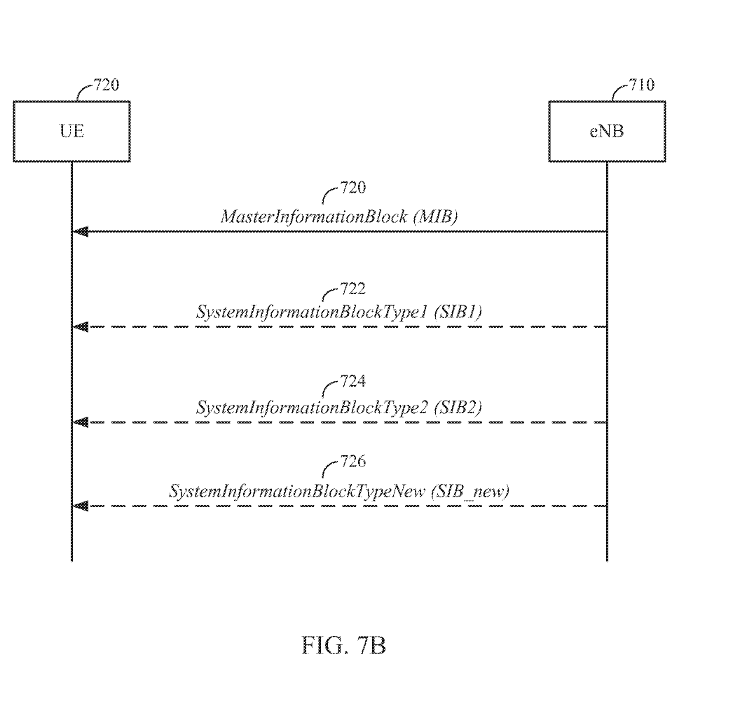

According to one aspect of the disclosure, FIG. 7A illustrates an exemplary transmission structure 700 that may be used on a downlink in a shared spectrum and/or mixed communication network environment that may involve multiple operators communicating over unlicensed bands. As shown in FIG. 7A, the transmission timeline may generally be partitioned into units of radio frames. Each radio frame may have a predetermined duration (e.g., 10 milliseconds) and may be partitioned into 10 subframes. Each subframe may include two slots, and each slot may include a fixed or configurable number of symbol periods (e.g., six or seven symbol periods).

The system bandwidth may be partitioned into multiple (K) subcarriers with orthogonal frequency division multiplexing (OFDM). The available time frequency resources may be divided into resource blocks. Each resource block may include Q subcarriers in one slot, where Q may be equal to 12 or some other value. The available resource blocks may be used to send data, overhead information, pilot, etc.

The system may support evolved multimedia broadcast/multicast services (eMBMS) for multiple UEs as well as unicast services for individual UEs. A service for eMBMS may be referred to as an eMBMS service or flow and may be a broadcast service/flow or a multicast service/flow.

In LTE, data and overhead information are processed as logical channels at a Radio Link Control (RLC) layer. The logical channels are mapped to transport channels at a Medium Access Control (MAC) layer. The transport channels are mapped to physical channels at a physical layer (PHY). Table 1 lists some logical channels (denoted as “L”), transport channels (denoted as “T”), and physical channels (denoted as “P”) used in LTE and provides a short description for each channel.

TABLE 1

| Name | Channel | Type | Description |
|---|---|---|---|
| Broadcast Control | BCCH | L | Carry system information |
| Channel | | | |
| Broadcast Channel | BCH | T | Carry master system |
| | | | Information |
| eMBMS Traffic | MTCH | L | Carry configuration |
| Channel | | | information for eMBMS |
| | | | services. |
| Multicast Channel | MCH | T | Carry the MTCH and MCCH |
| Downlink Shared | DL-SCH | T | Carry the MTCH and other |
| Channel | | | logical channels |
| Physical Broadcast | PBCH | P | Carry basic system |
| Channel | | | information for use in |
| | | | acquiring the system. |
| Physical Multicast | PMCH | P | Carry the MCH. |
| Channel | | | |
| Physical Downlink | PDSCH | P | Carry data for the DL-SCH |
| Shared Channel | | | |
| Physical Downlink | PDCCH | P | Carry control information |
| Control Channel | | | for the DL-SCH |

As shown in Table 1, different types of overhead information may be sent on different channels. Table 2 lists some types of overhead information and provides a short description for each type. Table 2 also gives the channel(s) on which each type of overhead information may be sent, in accordance with one design.

TABLE 2

| Overhead | | |
|---|---|---|
| Information | Channel | Description |
| System | BCCH | Information pertinent for communicating |
| Information | | with and/or receiving data from the system. |
| Configuration | MCCH | Information used to receive the Information |
| Information | | services, e.g., MBSFN Area Configuration, |
| | | which contains PMCH configurations, Service |
| | | ID, Session ID, etc. |
| Control | PDCCH | Information used to receive Information |
| Information | | transmissions of data for the services, |
| | | e.g., resource assignments, modulation and |
| | | coding schemes, etc. |

The different types of overhead information may also be referred to by other names. The scheduling and control information may be dynamic whereas the system and configuration information may be semi-static.

The system may support multiple operational modes for eMBMS, which may include a multi-cell mode and a single-cell mode. The multi-cell mode may have the following characteristics:
Content for broadcast or multicast services can be transmitted synchronously across multiple cells.
Radio resources for broadcast and multicast services are allocated by an MBMS Coordinating Entity (MCE), which may be logically located above the Node Bs.
Content for broadcast and multicast services is mapped on the MCH at a Node B.
Time division multiplexing (e.g., at subframe level) of data for broadcast, multicast, and unicast services.

The single-cell mode may have the following characteristics:
Each cell transmits content for broadcast and multicast services without synchronization with other cells.
Radio resources for broadcast and multicast services are allocated by the Node B.
Content for broadcast and multicast services is mapped on the DL-SCH.
Data for broadcast, multicast, and unicast services may be multiplexed in any manner allowed by the structure of the DL-SCH.

In general, eMBMS services may be supported with the multi-cell mode, the single-cell mode, and/or other modes. The multi-cell mode may be used for eMBMS multicast/broadcast single frequency network (MBSFN) transmission, which may allow a UE to combine signals received from multiple cells in order to improve reception performance.

According to one aspect of the disclosure, FIG. 7B illustrate exemplary signaling messages that may be broadcasted in a shared or unlicensed spectrum environment. For example, as shown in FIG. 7B, system information may be provided by radio resource control (RRC) and structured in master information blocks (MIBs) and system information blocks (SIBs). A MIB 720 is broadcasted in fixed location time slots by an eNB 710 and includes parameters to aid a UE 720 in locating a SIB Type 1 (SIB1) message 722 scheduled on the DL-SCH (e.g., DL bandwidth and system frame number). The SIB1 message 722 contains information relevant to scheduling the other system information and information on access to a cell. The other SIBs are multiplexed in system information messages. A SIB Type 2 (SIB2) message 724 contains resource configuration information that is common to all UEs 720 and information on access barring. The eNB 710 controls user access by broadcasting access class barring parameters in a SIB2 message 724, and the UE 720 performs actions according to the access class in its universal subscriber identity module (USIM).

All UEs 720 that are members of access classes one to ten are randomly allocated mobile populations, defined as access classes 0 to 9. The population number is stored in the SIM/USIM. In addition, UEs 720 may be members of one or more of five special categories (access classes 11 to 15) also held in the SIM/USIM. The standard defines these access classes as follows (3GPP TS 22.011, Section 4.2):
Class 15—Public Land Mobile Network (PLMN) Staff;
Class 14—Emergency Services;
Class 13—Public Utilities (e.g. water/gas suppliers);
Class 12—Security Services; and
Class 11—For PLMN Use.

A SIB2 message contains the following parameters for access control:
For regular users with Access Class 0 to 9, the access is controlled by ac-BarringFactor and ac-BarringTime parameters in the SIB2 message.
For users initiating emergency calls (AC 10) the access is controlled by the ac-BarringForEmergency parameter, indicating whether access barring is enforced or not enforced.
For UEs 720 with AC 11 to 15, the access is controlled by the ac-BarringForSpecialAC parameter, indicating whether access barring is enforced or not enforced.

A UE 720 is allowed to perform access procedures when the UE 720 is a member of at least one access class that corresponds to the permitted classes as signaled over the air interface. The UEs 720 generate a random number to pass the “persistent” test in order for the UE 720 to gain access. To gain access, the outcome from a UE's 720 random number generator needs to be lower than the threshold set in the ac-BarringFactor. By setting the ac-BarringFactor to a lower value, the access from regular users is restricted. The users with access class 11 to 15 can gain access without any restriction.

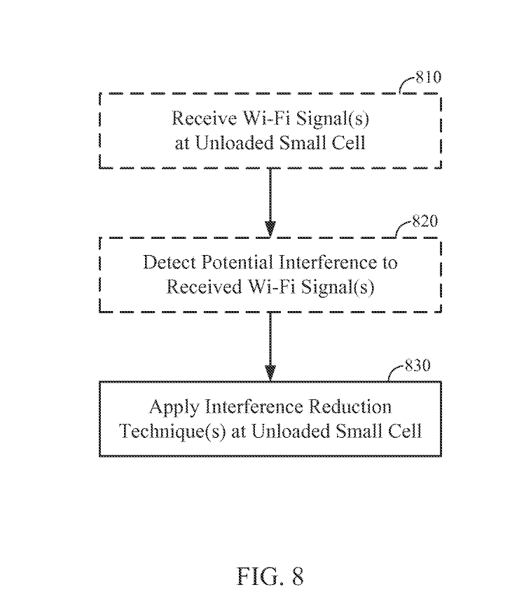

According to one aspect of the disclosure, FIG. 8 illustrates an exemplary method 800 to reduce interference from an unloaded small cell that provides cellular (e.g., LTE) coverage in unlicensed bands. For example, referring back to FIG. 6, it may be advantageous to adapt a configuration that the small cell 601 uses to provide cellular coverage (e.g., on one or more unlicensed carriers) to reduce interference to other Wi-Fi APs operating on the same channel. For example, the configuration that the small cell 601 uses to operate on the one or more unlicensed carriers may be adapted if the small cell 601 is unloaded (e.g., if there is no buffered traffic, buffered traffic below a threshold, etc.), if capacity is limited by the backhaul and not by licensed carrier capacity, or when other suitable conditions exist. For example, in the case of a shared backhaul where the backhaul bandwidth may become limited due to other devices (e.g., a TV, gaming console, etc.) sharing the backhaul, the licensed carrier may proficiently handle the over-the-air traffic corresponding to the backhaul bandwidth availability. Adapting the unlicensed carrier configuration associated with the small cell 601 may therefore help to reduce pilot pollution and improve network capacity and coverage, among other advantages. Conversely, it may be advantageous to adapt the configuration associated with the small cell 601 in certain situations if certain capacity requirements are not being adequately handled by the licensed carriers (e.g., based on buffer size, number of users, etc.). Accordingly, the method 800 shown in FIG. 8 may generally provide various techniques to reduce Wi-Fi interference and to tradeoff coverage, capacity, and interference impact from an unloaded small cell that provides cellular coverage in unlicensed bands (e.g., the small cell 601).

More particularly, the method 800 may be initiated when an unloaded small cell (e.g., a small cell having no buffered traffic or traffic below a threshold) detects one or more Wi-Fi signals at block 810 and determines that cellular signals that the unloaded small cell transmits and/or receives may cause the potential interference with the Wi-Fi signals at block 820. As such, the unloaded small cell may then apply one or more interference reduction techniques at block 830 to reduce or otherwise mitigate the potential interference with the Wi-Fi signals detected at block 810. Alternatively, the unloaded small cell may autonomously apply the one or more interference reduction techniques at block 830 without detecting any Wi-Fi signals (e.g., to prevent pilot pollution, improve power consumption and/or resource availability, reduce interference with Wi-Fi signals that may potentially exist around the unloaded small cell despite being undetected, or to otherwise improve signal quality, performance, etc.). In either case, as will be described in further detail herein, the interference reduction techniques applied at block 830 may be selected from among switching the unloaded small cell to a low downlink configuration, switching the unloaded small cell to a low bandwidth configuration, moving the unloaded small cell and one or more additional small cells to the same frequency and/or channel number, adapting a transmit power associated with the small cell, and/or any suitable combination thereof. Furthermore, those skilled in the art will appreciate that the interference reduction techniques applied at block 830 may include one of the above-mentioned interference reduction techniques or more than one of the above-mentioned interference reduction techniques that may be applied in any suitable combination. Further still, those skilled in the art will appreciate that where the interference reduction techniques applied at block 830 include multiple interference reduction techniques, the multiple interference reduction techniques need not be applied in any particular sequence or order (e.g., the multiple interference reduction techniques may be applied simultaneously, sequentially, or any suitable combination thereof).

In one example, when the interference reduction technique(s) applied at block 830 include switching the unloaded small cell to a low downlink configuration, the low downlink configuration may comprise a time division duplexing (TDD) Config0 and special subframe (SSF) Config5 downlink configuration, which can generally be performed through signaling using the system information blocks (SIBs) described above with respect to FIG. 7B. For example, Table 3 illustrated below generally summarizes the different TDD configuration modes that may be available, switch point periodicities for each available TDD configuration mode, and allocations in each subframe for the given TDD configuration to uplink transmissions (“U”), downlink transmissions (“D”), or special signals (“S”).

TABLE 3
LTE TDD Configurations

| UL-DL | DL-to-UL | | | | | | | | | | |
|---|---|---|---|---|---|---|---|---|---|---|---|
| Config- | Switch Point | Subframe Number | | | | | | | | | |
| uration | Periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

Within a radio frame, LTE TDD switches multiple times between downlink and uplink transmission and vice versa, during which time different signal transit times between the small cell and various UEs must be considered to prevent conflicts with the neighboring subframe. The timing advance process may prevent conflicts when switching from the uplink to the downlink, whereby the small cell may inform every UE as to when the UE should start to transmit to help ensure that all signals reach the small cell in a synchronized manner. When switching from the downlink to the uplink, a guard period (GP) may be inserted between a downlink pilot time slot (DwPTS) and an uplink pilot time slot (UpPTS) field. The GP may have a duration that depends on the signal propagation time between the small cell and the UE and the time the UE requires to switch from receiving to sending. As such, each special subframe (“S”) may have a DwPTS field, a UpPTS field, and a GP field, wherein different SSF configurations available for LTE TDD are summarized in Table 4 below.

TABLE 4
SSF Configurations in LTE TDD

| SSF | | | | | | |
|---|---|---|---|---|---|---|
| Con- | | | | | | |
| figura- | Extended Cyclic Prefix Length | | | Normal Cyclic Prefix Length | | |
| tion | DwPTS | GP | UpPTS | DwPTS | GP | UpPTS |
| 0 | 3 | 8 | 1 | 3 | 10 | 1 |
| 1 | 8 | 3 | | 9 | 4 | |
| 2 | 9 | 2 | | 10 | 3 | |
| 3 | 10 | 1 | | 11 | 2 | |
| 4 | 3 | 7 | 2 | 12 | 1 | |
| 5 | 8 | 2 | | 3 | 9 | 2 |
| 6 | 9 | 1 | | 9 | 3 | |
| 7 | — | — | — | 10 | 2 | |
| 8 | — | — | — | 11 | 1 | |

Accordingly, at block 830, the unloaded small cell may be switched to the low downlink configuration that corresponds to TDD Config0 (DSUUUDSUUU) and SSF Config5 (three downlink symbols). Furthermore, because switching to the low downlink TDD configuration may result in bursty interference due to different small cells and/or other eNBs transmitting different TDD configurations, rate control loops may be appropriately modified to adapt to the bursty interference that may result from the switch to the low downlink TDD configuration. For example, there could be dual channel quality indicator (CQI) reports from a UE, which may include a first CQI report for subframes 0/5 to indicate interference during the downlink subframes and a second CQI reports for the remaining subframes to indicate interference during the uplink subframes. Alternatively, the UE could alternate CQI feedback, wherein the UE may provide a CQI report to represent the downlink interference on subframes 0/5 in a first interval and then provide a CQI report to represent the uplink interference on the remaining subframes in a second interval, and then provide CQI reports to represent the downlink interference on subframes 0/5 and the uplink interference on the remaining subframes in third and fourth intervals, and so on. Furthermore, in LTE, channel estimation and CQI filtering may take the downlink configuration into account. For example, interference estimation on subframe 0/5 can be averaged separately such that subframe 0/5 does not impact interference estimation done on subframes 1/4/9. Furthermore, those skilled in the art will appreciate that the TDD Config0 and SSF Config5 downlink configuration simply represents one exemplary low downlink configuration to which the unloaded small cell may be switched, and that the unloaded small cell may be appropriately switched to other suitable low downlink configurations.

In another example, when the interference reduction technique(s) applied at block 830 include switching the unloaded small cell to a low bandwidth configuration (e.g., a 1.25 MHz bandwidth configuration), which can generally be performed through signaling using the master information blocks (MIBs) described above with respect to FIG. 7B. In this respect, intra-frequency and inter-frequency measurements may be performed over six transmission resource blocks (RBs). Furthermore, whether the unloaded small cell can be switched to the low bandwidth configuration at block 830 may depend on the particular implementation associated with the unloaded small cell (e.g., how often the small cell can switch bandwidths without impacting performance). Further still, those skilled in the art will appreciate that the 1.25 MHz bandwidth configuration simply represents one exemplary low bandwidth configuration to which the unloaded small cell may be switched, and that the unloaded small cell may be appropriately switched to other suitable low bandwidth configurations.

In another example, when there are multiple unloaded small cells that may potentially interfere with the Wi-Fi signals received at block 810, the interference reduction technique(s) applied at block 830 may include moving all of the multiple unloaded small cells to the same frequency and/or channel number.

In another example, when the interference reduction technique(s) applied at block 830 include adapting the transmit power associated with the small cell, block 830 may include adapting the transmit power associated with the small cell to balance tradeoffs between network coverage, capacity, and interference impact. In particular, the transmit power associated with the small cell may be adapted to optimize network capacity and minimize pilot pollution using a power management framework that may dynamically adapt to a network topology based on network listening and/or UE-assisted measurements. More particularly, the power management framework may use cellular measurements in combination with Wi-Fi measurements to adapt the transmit power associated with the small cell that provides cellular coverage in unlicensed bands, whereas transmit power management performed in licensed bands typically relies solely upon cellular measurements. For example, if the small cell measures a Wi-Fi signal that exceeds a first threshold (e.g., a threshold above which the small cell may cause interference with the Wi-Fi signal), the small cell may appropriately reduce the transmit power associated therewith in accordance with other cellular measurements (e.g., received signal code power (RSCP) measurements that indicate the power associated with cellular signals that are received and measured at the small cell, reported from a UE, etc.). In this example, the small cell may aggressively reduce the transmit power associated therewith to reduce interference with the Wi-Fi signal determined to exceed the first threshold in response to the other cellular measurements indicating that the total RSCP associated with the measured cellular signals exceeds an RSCP threshold. Furthermore, in order to balance tradeoffs between coverage, capacity, and interference impact, the RSCP threshold may be appropriately adapted based on the Wi-Fi measurements. For example, the RSCP threshold may be reduced in response to determining that the Wi-Fi measurements exceed a second threshold, whereby the transmit power associated with the small cell may be reduced more aggressively when stronger Wi-Fi signals are measured. Relatedly, the RSCP threshold may be increased in response to determining that the Wi-Fi measurements fall below the second threshold and/or the first threshold, whereby the transmit power associated with the small cell may be reduced less aggressively when weak Wi-Fi signals are measured.

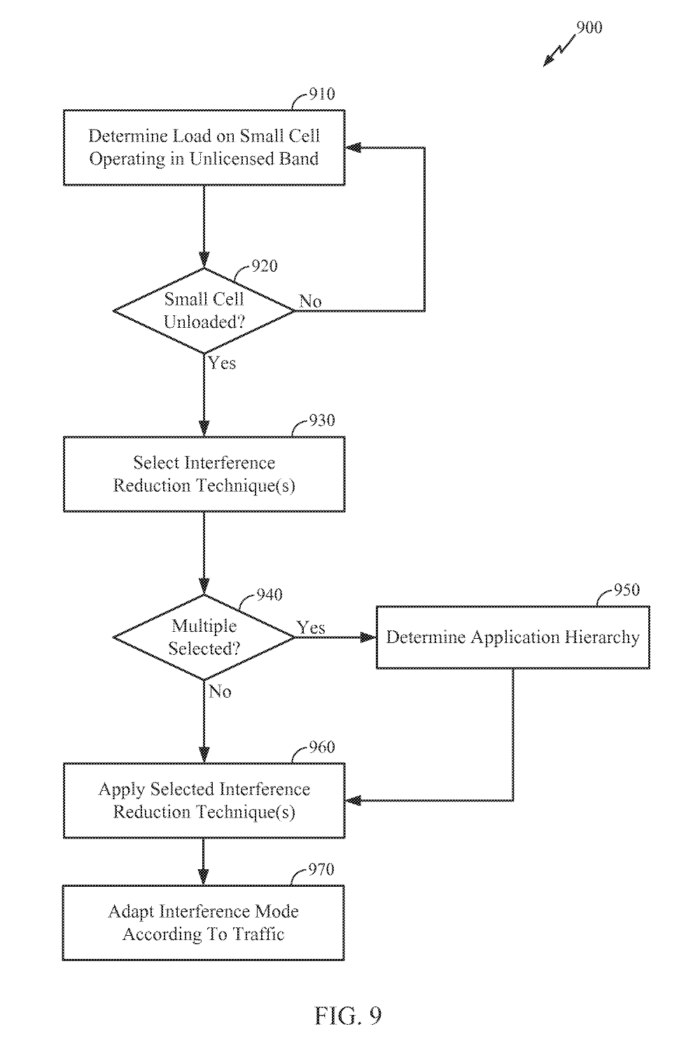

According to one aspect of the disclosure, FIG. 9 illustrates another exemplary method 900 to reduce interference from an unloaded small cell that provides cellular (e.g., LTE) coverage in unlicensed bands. More particularly, during normal operation, the small cell may transmit all appropriate pilot signals that are typically needed for control, continuity, synchronization, reference, or other suitable purposes (e.g., common reference signals, overhead signals, etc.), and furthermore, the small cell may need to continuously transmit all the pilot signals when operating in licensed bands for mobility and other reasons that will generally be apparent to those skilled in the art. However, when a small cell operates in unlicensed bands to provide cellular coverage over a relatively small coverage area, the small cell may not need to transmit the pilot signals all the time, and may preferably not transmit the pilot signals all the time to avoid pilot pollution and mitigate potential interference with Wi-Fi devices that may be operating within or near to a coverage area associated with the small cell.

As such, in one implementation, a small cell that provides cellular coverage in unlicensed bands may determine a load associated therewith at block 910 and then determine at block 920 whether the small cell is sufficiently unloaded (e.g., has no traffic or traffic below a threshold) to allow a configuration associated therewith to be switched in a manner that may reduce pilot pollution and mitigate potential interference with Wi-Fi devices that may be operating in or near to the coverage area associated with the small cell. For example, in response to an initial determination that the small cell has ongoing traffic or ongoing traffic that exceeds a certain threshold level at block 920, the small cell may continue to operate in the normal manner without switching to a reduced interference configuration and continue to monitor the load associated therewith at blocks 910 and 920 to determine whether the small cell has a sufficiently unloaded state to trigger the switch to the reduced interference mode. Accordingly, once the small cell is sufficiently unloaded, the small cell may then select one or more interference reduction techniques that may be designed to reduce pilot pollution and mitigate potential interference with Wi-Fi devices that may be operating in or near to the coverage area associated with the small cell at block 930.

In particular, as described above with reference to FIG. 8, the interference reduction techniques selected at block 930 may include switching to a low downlink configuration, switching to a low bandwidth configuration, switching to the same frequency and/or channel number as any other unloaded small cells, reducing a transmit power, and/or any suitable combination thereof

In one implementation, the interference reduction techniques may be provided in a time domain, where switching to the low downlink configuration may assume that the small cell operates according to time division duplexing (TDD) in which each frame may include one or more uplink subframes and one or more downlink subframes. As such, the low downlink configuration may generally have fewer downlink subframes and more uplink subframes, which may not cause a substantial degradation in service because the small cell was determined to be unloaded and therefore does not have substantial traffic. For example, in one implementation, the low downlink configuration may comprise TDD Config0, which has one downlink subframe, one special subframe (SSF) divided between uplink and downlink symbols, and the remaining subframes are all uplink subframes. Furthermore, in the special subframe that generally transitions between the downlink and uplink, the first few symbols are downlink, then a gap allows for the switch between the uplink and the downlink, and the next few symbols are uplink, wherein the special subframe may also be configurable. As such, the low downlink configuration may further include an SSF configuration having few downlink symbols (e.g., SSF Config5, which has three downlink symbols).

In one implementation, the interference reduction techniques may be further provided in a frequency domain, where the small cell may switch to the low bandwidth configuration and/or switch to the same frequency and/or channel number as any other unloaded small cells. In the former case, the low bandwidth configuration may generally comprise the lowest possible bandwidth that supports the cellular coverage that the small cell provides. For example, a small cell that provides cellular coverage in unlicensed bands may generally be deployed in 20 MHz, which may be reduced to 1.25 MHz when traffic is low, thereby reducing potential interference to any Wi-Fi devices that may be operating within or near to the coverage area associated with the small cell by a factor of about 13 dB (i.e., 20 MHz/1.25 MHz). In the latter case, the unloaded small cell may switch to a specific agreed-upon channel and/or frequency that all small cells switch to when unloaded, whereby all interference will be concentrated on the same channel and/or frequency and all other channels and/or frequencies may be free from interference for Wi-Fi operation.

In one implementation, the interference reduction techniques may be further provided in a power domain, where the small cell may take measurements from other small cells into account in addition to input from Wi-Fi access points or other Wi-Fi devices that may be operating within or near to the coverage area associated with the small cell. More specifically, as described in further detail above with respect to FIG. 8, the unloaded small cell may dynamically adapt a transmit power associated therewith to balance tradeoffs between network coverage, capacity, and interference impact and calculate a power backoff adapted to optimize network capacity and minimize pilot pollution based on cellular measurements in combination with Wi-Fi measurements, whereas managing transmit power in licensed bands typically relies solely upon cellular measurements. For example, if the unloaded small cell measures a Wi-Fi signal that exceeds a first threshold, the small cell may appropriately reduce the transmit power associated therewith in response to cellular signals that are received and measured at the small cell and/or reported to the small cell having a total received signal code power (RSCP) that exceeds an RSCP threshold. Furthermore, the RSCP threshold may be reduced if the Wi-Fi measurements exceed a second threshold, whereby the transmit power associated with the small cell may be reduced more aggressively when stronger Wi-Fi signals are measured, or the RSCP threshold may alternatively be increased if the Wi-Fi measurements fall below the second threshold and/or the first threshold, whereby the transmit power associated with the small cell may be reduced less aggressively when weak Wi-Fi signals are measured.

In any case, the unloaded small cell may generally select one or more of the above-mentioned interference reduction techniques in the time domain, the frequency domain, the power domain, and/or any suitable combination thereof at block 930, wherein block 940 may then include determining whether multiple interference reduction techniques were selected. In particular, if only one interference reduction technique was selected, the small cell may simply apply the selected interference reduction techniques at block 960. However, in response to determining that multiple interference reduction techniques were selected, the small cell may determine a hierarchy or order in which to apply the selected interference reduction techniques at block 950. In one implementation, the hierarchy may generally include first switching the small cell to the same channel and/or frequency as other unloaded small cells (e.g., to eliminate interference on all but one channel and/or frequency) and switching to the low bandwidth configuration second (e.g., because switching the bandwidth configuration may require a reboot and because signaling to indicate the switch in the bandwidth configuration typically happens in a Master Information Block (MIB), which may be at a higher signaling level than signaling to indicate a switch in the TDD downlink configuration, which typically happens in System Information Blocks (SIBs). In one implementation, the hierarchy may then include switching the TDD downlink configuration, which can happen on-the-fly (e.g., in less than one second), and lastly taking cellular and Wi-Fi measurements to decide about whether to invoke a power backoff in the power domain. As such, at block 960, the small cell may then apply the multiple interference reduction techniques that were selected in accordance with the hierarchy or order that was determined at block 950.

For example, in one implementation, if the interference reduction technique(s) selected at block 930 include switching to the same frequency and/or channel number as any other unloaded small cells in the frequency domain, block 960 may include switching to the agreed-upon channel and/or frequency to which all small cells should switch when having an unloaded state and optionally instructing any UEs that may be connected to the unloaded state (e.g., UEs in an idle state that have little or no current traffic requirements) to likewise switch to the agreed-upon channel and/or frequency that the small cell switched to due to having the unloaded state. Furthermore, if the selected interference reduction technique(s) include switching to the low bandwidth configuration, block 960 may include rebooting the unloaded small cell to invoke the switch to the low bandwidth configuration (if necessary) transmitting appropriate signaling messages within one or more MIBs such that any connected UEs may know that the bandwidth configuration associated with the unloaded small cell has changed and thereby make appropriate adjustments based on the new bandwidth configuration.

Alternatively (or additionally), if the selected interference reduction technique(s) include switching to the low downlink configuration, block 960 may include determining an appropriate TDD configuration and SSF configuration that have relatively few downlink subframes and downlink symbols, respectively, which may be adapted based on the current traffic or load associated with the small cell. For example, in general, TDD Config0 and SSF Config5 may provide the least downlink activity and therefore provide the most substantial reduction in interference, whereby TDD Config0 and SSF Config5 may be selected if the small cell currently has no downlink traffic to send. Alternatively, if the small cell has some (but very little) downlink traffic to send, the small cell may switch to TDD Config6, which has the next fewest downlink subframes (i.e., three downlink subframes, whereas TDD Config0 has two downlink subframes). Accordingly, those skilled in the art will appreciate that the low downlink configuration may generally reduce downlink transmissions relative to normal operation in a manner that may be adapted to current downlink traffic requirements. Furthermore, to apply to switch to the low downlink configuration, block 960 may further include transmitting appropriate signaling messages within one or more SIBs such that any connected UEs may know the new TDD and/or SSF configuration associated with the unloaded small cell and thereby make appropriate adjustments to remain synchronized with the downlink configuration associated with the small cell. Additionally, in one implementation, applying the switch to the low downlink configuration at block 960 may further include scheduling appropriate signaling messages within one or more SIBs such that any connected UEs may know the new TDD and/or SSF configuration associated with the unloaded small cell and thereby make appropriate adjustments to remain synchronized with the downlink configuration associated with the small cell. Additionally, in one implementation, applying the switch to the low downlink configuration at block 960 may further scheduling channel quality indicator (CQI) reports from any connected UEs, wherein the small cell may schedule dual CQI reports in each feedback period such that a first CQI report provides feedback that reflects interference during the downlink subframes (e.g., subframes 0 and 5 in TDD Config0) and a second CQI report provides feedback that reflects interference during the uplink and special subframes, or the small cell may alternatively schedule alternating CQI reports such that a CQI report provided in a first feedback period reflects interference during the downlink subframes, a CQI report provided in a second feedback period reflects interference during the uplink and special subframes, a CQI report provided in a third feedback period reflects interference during the downlink subframes, and so on.

Furthermore, if the selected interference reduction technique(s) include adapting the transmit power associated with the unloaded small cell in the power domain, block 960 may include obtaining cellular measurements and Wi-Fi measurements to calculate an appropriate power backoff. More particularly, as noted above, the power backoff may be calculated to optimize network capacity, minimize pilot pollution, and mitigate potential interference to Wi-Fi devices that may be operating within or near to the coverage area associated with the small cell based on network listening and/or UE-assisted measurements. For example, in one implementation, any Wi-Fi signals that are received at the unloaded small cell may be measured and compared to a first threshold, wherein the small cell may determine that transmissions therefrom may interference with the Wi-Fi signals if the Wi-Fi measurements exceed the first threshold. In that case, the unloaded small cell may calculate a suitable power backoff to reduce the potential interference in response to measured cellular signals having a total RSCP that exceeds an RSCP threshold, which may be further adapted based on the Wi-Fi measurements. For example, the RSCP threshold may be reduced if the Wi-Fi measurements exceed a second threshold, whereby the transmit power associated with the small cell may be reduced more aggressively when stronger Wi-Fi signals are measured, or the RSCP threshold may alternatively be increased if the Wi-Fi measurements fall below the second threshold and/or the first threshold, whereby the transmit power associated with the small cell may be reduced less aggressively when weak Wi-Fi signals are measured. As such, adapting the transmit power at block 960 may generally comprise calculating an appropriate power backoff according to measurements associated with cellular signals and Wi-Fi signals, which may be taken at the small cell, reported to the small cell, or any suitable combination thereof

In one implementation, after having suitably applied the selected interference reduction technique(s) at block 960, the small cell may again determine a load associated therewith and determine whether a sufficiently unloaded state exists such that the interference mode may be adapted to changes in the load or traffic associated with the small cell at block 970. For example, if the small cell initially had minimal traffic that was below the threshold and subsequently determines that there is no current traffic at all, at block 970 the small cell may apply further interference reduction technique(s) to the extent that one or more were not initially applied and/or more aggressively apply one or more interference reduction technique(s) that were previously applied (e.g., further reducing the transmit power, further reducing the bandwidth configuration, etc.). Alternatively, if the small cell determines that the load has increased such that the small cell can no longer be considered substantially unloaded, at block 970 the small cell may adapt the previously applied interference reduction technique(s) according to the increased load. For example, if the small cell previously detected an unloaded state and switched to the low downlink configuration, the small cell may switch the configuration to a TDD configuration that has more downlink subframes and an SFF configuration that has more downlink symbols when the small cell is no longer unloaded. Likewise, if the small cell previously switched to the low bandwidth configuration, the small cell may return to a high bandwidth configuration once the small cell is no longer unloaded. Furthermore, when exiting the reduced interference mode at block 970, the small cell may determine whether multiple interference reduction techniques were previously applied and appropriately switch configurations based on the more loaded state in a similar manner to that described above where multiple interference reduction techniques are applied in the unloaded state according to a particular hierarchy.

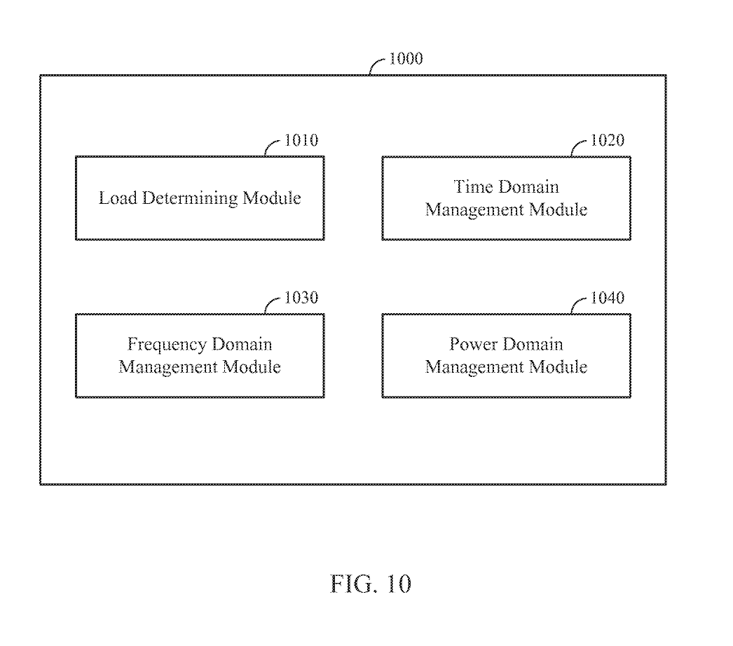

According to one aspect of the disclosure, FIG. 10 illustrates an exemplary modular architecture 1000 that may be used to reduce interference from an unloaded small cell that provides cellular coverage in unlicensed bands. More particularly, in one implementation, the modular architecture 1000 may include a load determining module 1010 that may generally monitor a load associated with the small cell to determine whether the small cell is sufficiently unloaded to invoke one or more other modules that may be configured to reduce pilot pollution and mitigate potential Wi-Fi interference (e.g., when the small cell has no buffered traffic, buffered traffic below a threshold, etc.). Additionally, in one implementation, the load determining module 1010 may determine whether capacity is limited by a backhaul and not by licensed carrier capacity, or when other suitable conditions exist such that the other modules configured to reduce pilot pollution and mitigate potential Wi-Fi interference may be invoked. For example, in a use case where backhaul bandwidth may become limited due to other devices sharing the backhaul, a licensed carrier may proficiently handle over-the-air traffic corresponding to the backhaul bandwidth availability. Adapting the unlicensed carrier configuration may therefore help to reduce pilot pollution and improve network capacity and coverage, among other advantages. Conversely, it may be advantageous to adapt the configuration associated with the small cell in certain situations if certain capacity requirements are not being adequately handled by the licensed carriers (e.g., based on buffer size, number of users, etc.). Accordingly, the load determining module 1010 may generally determine whether suitable conditions exist to adapt the unlicensed configuration associated with the small cell to reduce Wi-Fi interference in a manner that may balance tradeoffs among coverage, capacity, and interference impact.

In one example, when the load determining module 1010 determines that suitable conditions exist to adapt the unlicensed configuration associated with the small cell (e.g., based on the small cell having an unloaded state), the load determining module 1010 may invoke a time domain management module 1020 that may switch the unloaded small cell to a low downlink configuration, which may comprise time division duplexing (TDD) Config0 and special subframe (SSF) Config5 (e.g., a TDD and SFF configuration that has less downlink activity). Furthermore, because switching to the low downlink TDD configuration may result in bursty interference due to different small cells and/or other eNBs transmitting different TDD configurations, the time domain management module 1020 may modify rate control loops to adapt to the bursty interference that may result from the switch to the low downlink configuration. For example, the time domain management module 1020 may schedule dual CQI reports from a UE, which may include a first CQI report to indicate interference during the downlink subframes and a second CQI reports to indicate interference during the remaining subframes. Alternatively, the time domain management module 1020 may schedule alternate CQI feedback, wherein a CQI report to represent interference on the downlink subframes may be scheduled in a first interval, a CQI report to represent the interference on the remaining subframes may be scheduled in a second interval, and so on. Furthermore, in LTE, channel estimation and CQI filtering may take the low downlink configuration into account. For example, interference estimation on the downlink subframes can be averaged separately such that the downlink subframes do not impact interference estimation done on subframes prior to and/or subsequent to the downlink subframes.

In another example, when the load determining module 1010 determines that the suitable conditions exist to adapt the unlicensed configuration associated with the small cell (e.g., based on the small cell having an unloaded state), the load determining module 1010 may invoke a frequency domain management module 1030 that may switch the small cell to a low bandwidth configuration (e.g., a 1.25 MHz bandwidth configuration). Furthermore, the frequency domain management module 1030 may determine whether the small cell can be switched to the low bandwidth configuration based on the particular implementation associated with the small cell (e.g., how often the small cell can switch bandwidths without impacting performance). Further still, the frequency domain management module 1030 may switch the small cell to an agreed-upon channel number and/or frequency that all unloaded small cells switch to when operating to reduce pilot pollution and/or Wi-Fi interference, thereby concentrating all pilot signal transmissions and potential interference on one channel and/or frequency and leaving all other channels and frequencies free from pilot signal transmissions and any potential interference.

In still another example, when the load determining module 1010 determines that the suitable conditions exist to adapt the unlicensed configuration associated with the small cell (e.g., based on the small cell having an unloaded state), the load determining module 1010 may invoke a power domain management module 1040 that may adapt a transmit power associated with the small cell to balance tradeoffs among network coverage, capacity, and interference impact. In particular, the power domain management module 1040 may adapt the transmit power associated with the small cell to optimize network capacity and minimize pilot pollution using a power management framework that may dynamically adapt to a network topology based on network listening and/or UE-assisted measurements. More particularly, the power domain management module 1040 may use cellular measurements in combination with Wi-Fi measurements to adapt the transmit power associated with the small cell in the unlicensed bands, whereas managing transmit power in licensed bands typically relies upon cellular measurements only. As such, the power domain management module 1040 may measure a Wi-Fi signal received at the small cell, wherein if the measured Wi-Fi signal exceeds a first threshold (e.g., a threshold above which the small cell may cause interference with the Wi-Fi signal), the power domain management module 1040 may appropriately reduce the transmit power associated with the small cell in accordance with other cellular measurements, which may include received signal code power (RSCP) measurements that indicate the power associated with cellular signals that are received and measured at the small cell, reported from a UE, etc. In this manner, the power domain management module 1040 may aggressively reduce the transmit power associated with the small cell to reduce interference with the Wi-Fi signal determined to exceed the first threshold if the other cellular measurements indicate that the total RSCP associated with the measured cellular signals exceeds an RSCP threshold. Furthermore, in order to balance tradeoffs between coverage, capacity, and interference impact, the power domain management module 1040 may adapt the RSCP threshold based on the Wi-Fi measurements. For example, the power domain management module 1040 may reduce the RSCP threshold if the Wi-Fi measurements exceed a second threshold and thereby reduce the transmit power associated with the small cell more aggressively when stronger Wi-Fi signals are measured. Relatedly, the power domain management module 1040 may increase the RSCP threshold if the Wi-Fi measurements fall below the second threshold and/or the first threshold and thereby reduce the transmit power associated with the small cell less aggressively when weak Wi-Fi signals are measured.

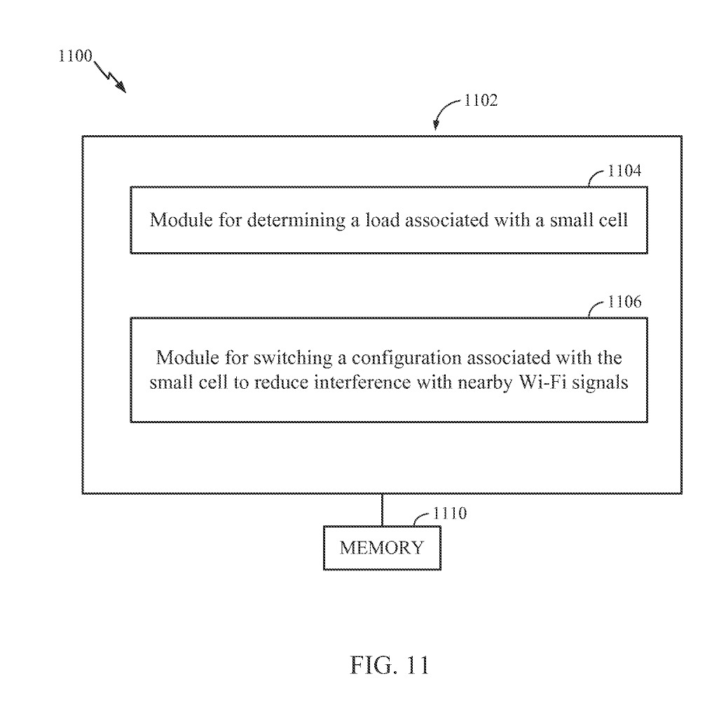

According to one aspect of the disclosure, FIG. 11 illustrates an exemplary system 1100 that may facilitate reducing interference from a small cell that provides cellular coverage in unlicensed bands. For example, the system 1100 shown in FIG. 11 can reside at least partially within the small cell or the system 1100 may alternatively reside entirely within the small cell or within an entity entirely independent from the small cell. Those skilled in the art will further appreciate that the system 1100 is represented as including functional blocks, which can be functional blocks that represent functions implemented by a processor, software, or combination thereof (e.g., firmware). In one implementation, the system 1100 may include a logical grouping of electrical components 1102 that may facilitate reducing interference from a small cell that provides cellular coverage in unlicensed bands. For instance, the logical grouping of electrical components 1102 may include a module 1104 for determining a load associated with the small cell. Further, the logical grouping of electrical components 1102 may comprise a module 1106 for switching a configuration associated with the small cell to reduce interference with Wi-Fi signals that may be transmitted within or near to the coverage area associated with the small cell (e.g., in response to the module 1104 determining that the small cell is substantially unloaded). Additionally, in various implementations, the module 1106 for switching the configuration associated with the small cell may be configured to invoke the switch in a time domain, a frequency domain, a power domain, or any suitable combination thereof Furthermore, the system 1100 can include a memory 1110 that retains instructions for executing functions associated with modules 1104 and 1106. While shown as being external to memory 1110, those skilled in the art will understand that the module 1104 and/or the module 1006 can exist within the memory 1110.

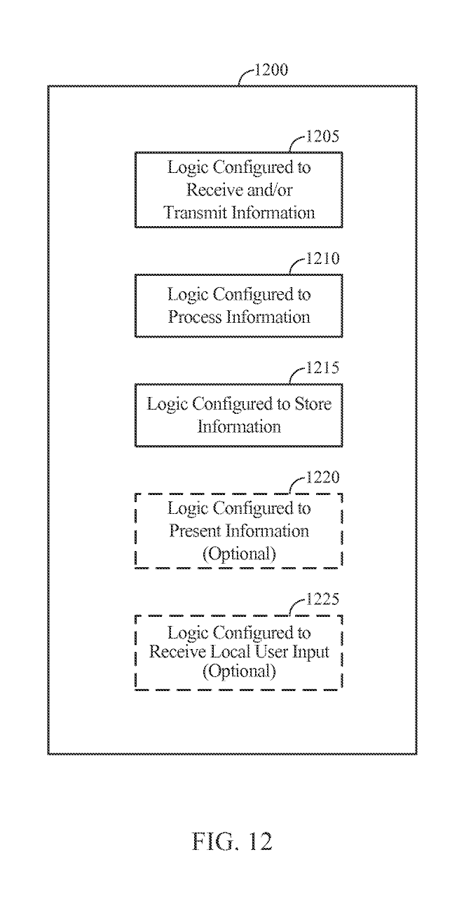

FIG. 12 illustrates a communication device 1200 that includes logic configured to perform functionality. The communication device 1200 can correspond to any of the above-noted communication devices, including but not limited to any component of the wireless communication networks 100 and 200, any component of the mixed communication network environment 500, the small cell 601, the user devices 602, etc.

Referring to FIG. 12, the communication device 1200 includes logic configured to receive and/or transmit information 1205. In an example, if the communication device 1200 corresponds to a wireless communications device (e.g., the small cell 601 or the user devices 602), the logic configured to receive and/or transmit information 1205 can include a wireless communications interface (e.g., Bluetooth, Wi-Fi, 2G, CDMA, W-CDMA, 3G, 4G, LTE, etc.) such as a wireless transceiver and associated hardware (e.g., an RF antenna, a MODEM, a modulator and/or demodulator, etc.). In another example, the logic configured to receive and/or transmit information 1205 can correspond to a wired communications interface (e.g., a serial connection, a USB or Firewire connection, an Ethernet connection through which the Internet can be accessed, etc.). Thus, if the communication device 1200 corresponds to some type of network-based server (e.g., an application server), the logic configured to receive and/or transmit information 1205 can correspond to an Ethernet card, in an example, that connects the network-based server to other communication entities via an Ethernet protocol. In a further example, the logic configured to receive and/or transmit information 1205 can include sensory or measurement hardware by which the communication device 1200 can monitor its local environment (e.g., an accelerometer, a temperature sensor, a light sensor, an antenna for monitoring local RF signals, etc.). The logic configured to receive and/or transmit information 1205 can also include software that, when executed, permits the associated hardware of the logic configured to receive and/or transmit information 1205 to perform its reception and/or transmission function(s). However, the logic configured to receive and/or transmit information 1205 does not correspond to software alone, as the logic configured to receive and/or transmit information 1205 relies at least in part upon hardware to achieve its functionality.

Referring to FIG. 12, the communication device 1200 further includes logic configured to process information 1210. In an example, the logic configured to process information 1210 can include at least a processor. Example implementations of the type of processing that can be performed by the logic configured to process information 1210 includes but is not limited to performing determinations, establishing connections, making selections between different information options, performing evaluations related to data, interacting with sensors coupled to the communication device 1200 to perform measurement operations, converting information from one format to another (e.g., between different protocols such as .wmv to .avi, etc.), and so on. For example, the processor included in the logic configured to process information 1210 can correspond to a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also or alternatively be implemented as a combination of computing devices (e.g., a combination of a DSP and a microprocessor, a plurality of microprocessors, one or more microprocessors in conjunction with a DSP core, or any other such configuration). The logic configured to process information 1210 can also include software that, when executed, permits the associated hardware of the logic configured to process information 1210 to perform its processing function(s). However, the logic configured to process information 1210 does not correspond to software alone, and the logic configured to process information 1210 relies at least in part upon hardware to achieve its functionality.

Referring to FIG. 12, the communication device 1200 further includes logic configured to store information 1215. In an example, the logic configured to store information 1215 can include at least a non-transitory memory and associated hardware (e.g., a memory controller, etc.). For example, the non-transitory memory included in the logic configured to store information 1215 can correspond to RAM, flash memory, ROM, erasable programmable ROM (EPROM), EEPROM, registers, hard disk, a removable disk, a CD-ROM, or any other form of storage medium known in the art. The logic configured to store information 1215 can also include software that, when executed, permits the associated hardware of the logic configured to store information 1215 to perform its storage function(s). However, the logic configured to store information 1215 does not correspond to software alone, and the logic configured to store information 1215 relies at least in part upon hardware to achieve its functionality.

Referring to FIG. 12, the communication device 1200 further optionally includes logic configured to present information 1220. In an example, the logic configured to present information 1220 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 1200. The logic configured to present information 1220 can be omitted for certain communication devices, such as network communication devices that do not have a local user (e.g., network switches or routers, remote servers, etc.). The logic configured to present information 1220 can also include software that, when executed, permits the associated hardware of the logic configured to present information 1220 to perform its presentation function(s). However, the logic configured to present information 1220 does not correspond to software alone, and the logic configured to present information 1220 relies at least in part upon hardware to achieve its functionality.

Referring to FIG. 12, the communication device 1200 further optionally includes logic configured to receive local user input 1225. In an example, the logic configured to receive local user input 1225 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 1200. The logic configured to receive local user input 1225 can be omitted for certain communication devices, such as network communication devices that do not have a local user (e.g., network switches or routers, remote servers, etc.). The logic configured to receive local user input 1225 can also include software that, when executed, permits the associated hardware of the logic configured to receive local user input 1225 to perform its input reception function(s). However, the logic configured to receive local user input 1225 does not correspond to software alone, and the logic configured to receive local user input 1225 relies at least in part upon hardware to achieve its functionality.

Referring to FIG. 12, while the configured logics of 1205 through 1225 are shown as separate or distinct blocks in FIG. 12, it will be appreciated that the hardware and/or software by which the respective configured logic performs its functionality can overlap in part. For example, any software used to facilitate the functionality of the configured logics of 1205 through 1225 can be stored in the non-transitory memory associated with the logic configured to store information 1215, such that the configured logics of 1205 through 1225 each performs their functionality (i.e., in this case, software execution) based in part upon the operation of software stored by the logic configured to store information 1215. Likewise, hardware that is directly associated with one of the configured logics can be borrowed or used by other configured logics from time to time. For example, the processor of the logic configured to process information 1210 can format data into an appropriate format before being transmitted by the logic configured to receive and/or transmit information 1205, such that the logic configured to receive and/or transmit information 1205 performs its functionality (i.e., in this case, transmission of data) based in part upon the operation of hardware (i.e., the processor) associated with the logic configured to process information 1210.

Generally, unless stated otherwise explicitly, the terms “module,” “logic,” “component,” “system,” and the like as used throughout this disclosure are intended to invoke aspects that are at least partially implemented with hardware, and are not intended to map to software-only implementations that are independent of hardware. For example, a module, component, or the like may be, but is not limited to being, a process running on a processor, a processor, an object, an executable, a thread of execution, a program, and/or a computer. By way of illustration, both an application running on a computing device and the computing device can be a module, component, or the like. One or more modules, components, etc. can reside within a process and/or thread of execution and a module, component, etc. may be localized on one computer and/or distributed between two or more computers. In addition, these modules, components, etc. can execute from various computer readable media having various data structures stored thereon. The modules, components, etc. may communicate by way of local and/or remote processes such as in accordance with a signal having one or more data packets, such as data from one module, component, etc. interacting with another module, component, etc. in a local system, distributed system, and/or across a network such as the Internet with other systems by way of the signal. Also, it will be appreciated that the term “logic” or the phrase “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the aspects described below in more detail.

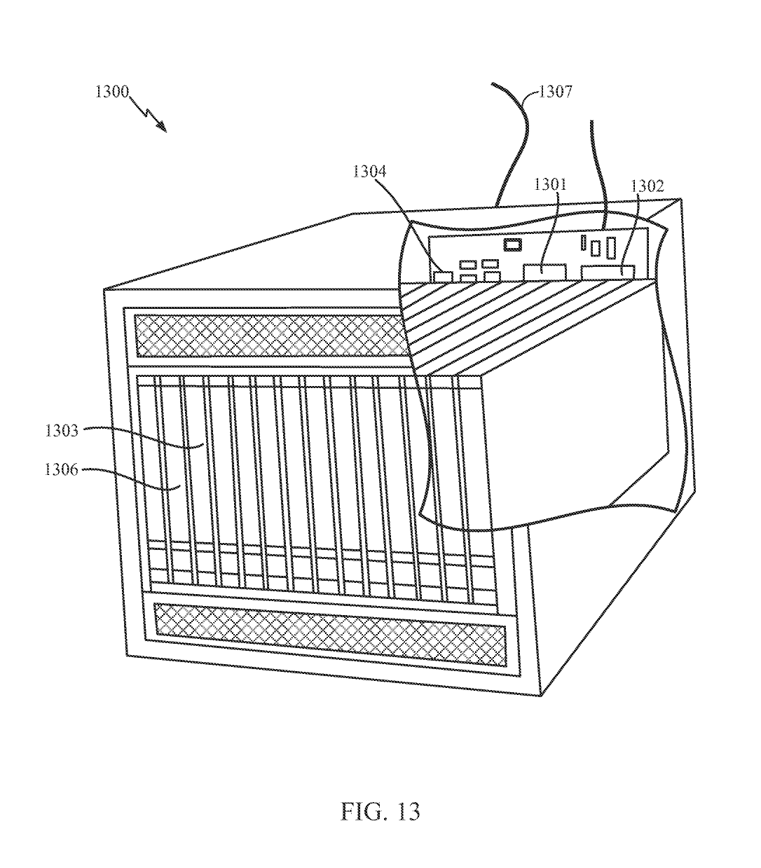

The various aspects may be implemented on any of a variety of commercially available server devices, such as server 1300 illustrated in FIG. 13. In an example, the server 1300 may correspond to one example configuration of the small cells described above. In FIG. 13, the server 1300 includes a processor 1301 coupled to volatile memory 1302 and a large capacity nonvolatile memory, such as a disk drive 1303. The server 1300 may also include a floppy disc drive, compact disc (CD) or DVD disc drive 1306 coupled to the processor 1301. The server 1300 may also include network access ports 1304 coupled to the processor 1301 for establishing data connections with a network 1307, such as a local area network coupled to other broadcast system computers and servers or to the Internet. In context with FIG. 12, it will be appreciated that the server 1300 of FIG. 13 illustrates one example implementation of the communication device 1200, whereby the logic configured to transmit and/or receive information 1205 may correspond to the network access points 1304 used by the server 1300 to communicate with the network 1307, the logic configured to process information 1210 may correspond to the processor 1301, and the logic configuration to store information 1215 may correspond to any combination of the volatile memory 1302, the disk drive 1303 and/or the disc drive 1306. The optional logic configured to present information 1220 and the optional logic configured to receive local user input 1225 are not shown explicitly in FIG. 13 and may or may not be included therein. Thus, FIG. 13 helps to demonstrate that the communication device 1200 may be implemented as a server, in addition to a UE implementation as described above.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the present disclosure.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In one or more exemplary aspects, the functions described may be implemented in hardware, software, firmware, or any combination thereof If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Accordingly, an aspect of the disclosure can include a computer readable media embodying a method for reducing interference from a small cell that provides cellular coverage in unlicensed bands. Accordingly, the disclosure is not limited to illustrated examples and any means for performing the functionality described herein are included in aspects of the disclosure.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method for reducing interference from a small cell that provides cellular coverage in unlicensed bands, comprising:
determining a load associated with the small cell; and
switching the small cell to a reduced interference configuration in response to the determined load indicating that traffic associated with the small cell is below a threshold, wherein the small cell switches to the reduced interference configuration in at least one of a time domain, a frequency domain, a power domain, or any combination thereof.

2. The method recited in claim 1, wherein switching the small cell to the reduced interference configuration in the time domain comprises:
switching the small cell to a low downlink configuration.

3. The method recited in claim 2, wherein the low downlink configuration comprises a time division duplexing (TDD) Config0 downlink configuration.

4. The method recited in claim 3, wherein the low downlink configuration further comprises a special subframe (SSF) Config5 downlink configuration.

5. The method recited in claim 1, wherein switching the small cell to the reduced interference configuration in the frequency domain comprises:
switching the small cell to a low bandwidth configuration.

6. The method recited in claim 5, wherein the low bandwidth configuration comprises a 1.25 MHz bandwidth configuration.

7. The method recited in claim 1, wherein the small cell comprises one of a plurality of small cells that have traffic below the threshold, and wherein switching the small cell to the reduced interference configuration in the frequency domain comprises:
moving the plurality of small cells to one or more of the same frequency, the same channel number, or any combination thereof.

8. The method recited in claim 1, wherein switching the small cell to the reduced interference configuration in the power domain comprises:
adapting a transmit power associated with the small cell based on one or more cellular measurements in combination with one or more Wi-Fi measurements.

9. The method recited in claim 8, wherein adapting the transmit power associated with the small cell comprises:
measuring one or more Wi-Fi signals at the small cell; and
determining a received signal code power (RSCP) threshold based on the one or more measured Wi-Fi signals.

10. The method recited in claim 9, wherein adapting the transmit power associated with the small cell further comprises:
measuring one or more cellular signals; and
reducing the transmit power associated with the small cell in response to the one or more measured Wi-Fi signals exceeding a first threshold and the one or more measured cellular signals exceeding the RSCP threshold.

11. The method recited in claim 10, wherein adapting the transmit power associated with the small cell further comprises:
reducing the RSCP threshold in response to the one or more measured Wi-Fi signals exceeding a second threshold.

12. The method recited in claim 1, wherein the small cell autonomously switches the reduced interference configuration to reduce pilot pollution, to mitigate potential interference with one or more Wi-Fi signals, or any combination thereof

13. The method recited in claim 1, further comprising:
exiting the reduced interference configuration in response to determining that the load associated with the small cell has changed such that the traffic associated with the small cell meets or exceeds the threshold.

14. A small cell, comprising:
an air interface configured to provide cellular coverage in unlicensed bands; and
a host comprising at least one processor configured to determine a load associated with the small cell and switch a configuration associated with the small cell in at least one of a time domain, a frequency domain, a power domain, or any combination thereof in response to the determined load indicating that the small cell has traffic below a threshold.

15. The small cell recited in claim 14, wherein the at least one processor is configured to switch the configuration associated with the small cell to a low downlink configuration to reduce interference in the time domain.

16. The small cell recited in claim 14, wherein the low downlink configuration comprises one or more of a time division duplexing (TDD) Config0 downlink configuration, a special subframe (SSF) Config5 downlink configuration, or any combination thereof

17. The small cell recited in claim 14, wherein the at least one processor is configured to switch the configuration associated with the small cell to a low bandwidth configuration to reduce interference in the frequency domain.

18. The small cell recited in claim 14, wherein the at least one processor is configured to switch the small cell to one or more of the same frequency or the same channel number as one or more additional small cells that have traffic below the threshold to reduce interference in the frequency domain.

19. The small cell recited in claim 14, wherein the at least one processor is configured to adapt a transmit power associated with the small based on one or more cellular measurements in combination with one or more Wi-Fi measurements to reduce interference in the power domain.

20. The small cell recited in claim 19, further comprising:
a first network listen module configured to measure one or more Wi-Fi signals, wherein the at least one processor is further configured to determine a received signal code power (RSCP) threshold based on the one or more measured Wi-Fi signals; and
a second network listen module configured to measure one or more cellular signals, wherein the at least one processor is further configured to reduce the transmit power associated with the small cell in response to the one or more measured Wi-Fi signals exceeding a first threshold and the one or more measured cellular signals exceeding the RSCP threshold.

21. The small cell recited in claim 20, wherein the at least one processor is further configured to reduce the RSCP threshold in response to the one or more measured Wi-Fi signals exceeding a second threshold.

22. The small cell recited in claim 14, wherein the at least one processor is further configured to switch the configuration associated with the small cell to a prior state in response to the small cell having traffic that meets or exceeds the threshold.

23. An apparatus, comprising:
means for determining a load associated with a small cell that provides cellular coverage in unlicensed bands; and
means for switching a configuration associated with the small cell to reduce interference in at least one of a time domain, a frequency domain, a power domain, or any combination thereof in response to the determined load indicating that traffic associated with the small cell is below a threshold.

24. The apparatus recited in claim 23, wherein the means for switching is configured to switch the configuration associated with the small cell to a low downlink configuration to reduce interference in the time domain.

25. The apparatus recited in claim 23, wherein the means for switching is configured to switch the configuration associated with the small cell to one or more of a low bandwidth configuration, the same frequency as one or more additional small cells that have traffic below the threshold, or the same channel number as the one or more additional small cells that have traffic below the threshold to reduce interference in the frequency domain.

26. The apparatus recited in claim 23, wherein the means for switching is configured to adapt a transmit power associated with the small based on one or more cellular measurements in combination with one or more Wi-Fi measurements to reduce interference in the power domain.

27. A computer-readable storage medium having computer-executable instructions recorded thereon, wherein executing the computer-executable instructions on at least one processor causes the at least one processor to:
determine a load associated with a small cell that provides cellular coverage in unlicensed bands; and
switch a configuration associated with the small cell to reduce interference in at least one of a time domain, a frequency domain, a power domain, or any combination thereof in response to the determined load indicating that the small cell has traffic below a threshold.

28. The computer-readable storage medium recited in claim 27, wherein executing the computer-executable instructions on the processor further causes the processor to switch the configuration associated with the small cell to a low downlink configuration to reduce interference in the time domain.

29. The computer-readable storage medium recited in claim 27, wherein executing the computer-executable instructions on the processor further causes the processor to switch the configuration associated with the small cell to one or more of a low bandwidth configuration, the same frequency as one or more additional small cells that have traffic below the threshold, or the same channel number as the one or more additional small cells that have traffic below the threshold to reduce interference in the frequency domain.

30. The computer-readable storage medium recited in claim 27, wherein executing the computer-executable instructions on the processor further causes the processor to adapt a transmit power associated with the small based on one or more cellular measurements in combination with one or more Wi-Fi measurements to reduce interference in the power domain.
